(19) United States
(12) Patent Application Publication
(10) Pub. No.: US 2002/0152245 A1
(43) Pub. Date: Oct. 17, 2002

(54) Web publication of newspaper content

(76) Inventors: Jeffrey McCaskey, Elma, NY (US); Renee Gauthier, Cowlesville, NY (US)

Correspondence Address: Thomas R. FitzGerald, Esq., JAECKLE FLEICHMANN & MUGEL, LLP, 39 State Street, Rochester, NY, 14614-1310, US

(21) Appl. No.: 09/827,019

(22) Filed: Apr. 5, 2001

(51) Int. Cl. G06F 17/21

(52) U.S. Cl. 707/530; 707/517

(57) ABSTRACT

An apparatus and method for receiving daily data feeds of news article text and news images, extracting from the articles both the text content and the formatting directives used in the newspaper layout, restructuring the formatting directives into organizing directives for Web pages, storing the text content and the organizing directives in a database, storing the news images in an image library, retrieving the text content and organizing directives from the database in a pattern which may be made significantly different from the pattern in which they were stored, and combining them with Web page templates to produce a Web-readable news publication. The Web-readable publication appears each day in synchronization with the daily paper news publication, and may be delivered on any schedule or cycle of news publication. Editorial maintenance programs facilitate skilled modification and enhancement of the content and appearance of the Web-readable publication. Classified advertisements and death notices are accommodated in the Web-readable publication. Customized electronic mail summaries of news are delivered to subscribers. The cost of news delivery and software maintenance is low.

### FIELD OF INVENTION

This invention is related to the electronic publication of text and images, and more specifically to the electronic publication of news text and news images on the World Wide Web.

### DEFINITIONS

“Basket” refers to a data element identifying a story's classification as used in news operations to separate stories by date, subject and location in the newsroom.

“Deck” refers to a data element identifying a secondary or alternative headline for if a story.

“Dynamic Web page” refers to a Web page which contains directives and program code processed on the Web server before being sent to the client for display to a reader. An example of a dynamic Web page is a Web page created with Active Server Pages (ASP) directives and program code embedded in it.

“Kicker” refers to a data element identifying a grouping or classification of a story, usually within a section, e.g.: “NFL” within “Sports”

“Link” refers to a hypertext reference embedded in a Web page, referring to another Web page. A link is also called a “Universal Record Locator”, or “URL”. Each link includes a display component which identifies that link to the viewer, and an address component which specifies the Web page to which the link refers.

“Marked up” means that directions concerning text formatting, story placement, and links to other text and information are embedded in the text itself.

“News presentation” here refers to the invention's complete set of Web pages presenting the current day's news, corresponding to the current day's printed newspaper and previous day's news stories.

“Reader” refers here to a person using a computer connected to the World Wide Web to display and interact with the news presentation.

“Section” refers to a data element the values of which identify a section of the newspaper in which a story may appear, e.g.: “Sports”, “Business”, “National/World”.

“Story” refers to a news story of any type, including, but not restricted to, obituaries, classified advertisements, columns, box scores, opinions, and picture captions.

“Topic” refers to a data element the values of which identify the specific subject area of a story as it appears in a given section. Examples of topics are: “NFL” within the Sports section, “Business News” within the Business section, or “Religion” within the Lifestyles section.

### DISCUSSION OF PRIOR ART

The World Wide Web has become a potent and pervasive outlet for news. A computer user connected to the World Wide Web can assimilate, in a matter of minutes, any number of pages of text, images, animations, films and other carriers of information originating from points all over the world. The speed and richness of assimilation from the World Wide Web far exceeds the possibilities of the familiar printed newspaper and broadcast forms of news transmission. Consequently the traditional news outlets, both newspaper and broadcast, have raced to provide their news via the World Wide Web, alongside their existing forms of conveyance.

Such a transition is neither easy nor inexpensive. A survey of the news outlets on the World Wide Web shows a wide variety of formats and approaches in use. Some require subscription. Some provide only a small portion of the news that appears in fall in their printed papers. Some require the use of special browser features or programs, to view parts of their content. The reader of news is faced with rules for reading the news on the Web which vary widely from one outlet to the next. This is a problem of ease of use.

The lack of common formats and rules of operation is not the only problem. Supporting the facade of any Web newspaper is a complex structure of interrelated Web pages, all of which must be developed, interconnected and presented on a daily or more-frequent basis from the news Website. The complexity of interconnections among news Web pages is driven by the need to assist the reader to move quickly and accurately from one article or portion of an article to another. This complexity requires considerable skilled effort in its installation. When the required effort is predominantly manual, as with some existing Websites for newspapers, the cost of producing the Web newspaper can easily exceed the parent newspaper's ability to fund it. This is a second major problem.

A third problem is that providing news over the World Wide Web offers little or no opportunity to recoup any of the costs of Web production from the reader. Faced with having to pay to get news from one source on the Web, a reader will simply turn to another news source which charges less or nothing. Therefore the Web news provider must look elsewhere for funding, and at the same time try to keep the cost of producing the Web version of the news as low as possible.

In an effort to reduce costs, some Web news suppliers have resorted to the use of simple automated methods to present news text with a minimum of formatting and little or no linkage among articles or portions of their news presentation. Such an approach forces the reader to do considerable work to extract information of interest from the articles presented. A reader in this situation will, as with sources charging for access, turn elsewhere.

The use of automated methods for news presentation on the Web creates a fourth major problem: the need to make ad hoc changes to the software programs which produce such news presentations. Some news stories have unusual formatting requirements. Some stories need links to other stories or Websites. Some stories have one or more characteristics which the existing software cannot convert for Web presentation. Such news stories require special processing, which can involve expensive, time-consuming and error-prone software changes.

Finally, a Web-based reader of the news would strongly appreciate customized news summaries derived from the Web version of the reader's favorite local newspaper and conveyed via electronic mail.

To summarize, the provision of news over the World Wide Web presents these challenges: improving ease of use, lowering the cost of production, avoiding charging the reader for reading the news, making the news presentation attractive, avoiding software changes wherever possible, and providing customized local news delivery to customers over the Web. Meeting all of these challenges at once would improve significantly the ability of news providers to compete successfully on the World Wide Web.

### SUMMARY

This invention receives daily data feeds of news article text and news images, extracts from the articles both the text content and the formatting directives used in the newspaper layout, restructures the formatting directives into organizing directives for Web pages, stores the text content and the organizing directives in a database, stores the news images in an image library, retrieves the text content and organizing directives from the database in a pattern which may be made significantly different from the pattern in which they were stored, and combines them with Web page templates to produce a Web-readable news publication. The Web-readable publication appears each day in synchronization with the daily paper news publication. The invention is adaptable to any schedule or cycle of news publication. The invention also provides editorial maintenance programs to facilitate skilled modification and enhancement of the content and appearance of the Web-readable publication. The invention further provides presentation of classified advertisements and death notices in the Web-readable publication. The invention still further reduces the cost of software maintenance, and provides customized electronic mail summaries of news delivered to subscribers. The invention's combination of features and capabilities provides for a low-cost, attractive, easy-to-use, and easy-to-maintain news publication on the World Wide Web, at no cost to the reader.

### DESCRIPTION OF DRAWINGS

FIG. 1 shows the overall layout of the invention's data and processing components.

FIG. 2 shows the invention's overall process and information flow.

FIG. 3 shows the tables of the editorial database, and their primary keys and relating fields.

FIG. 3a shows the Story table of the editorial database, and the related metaStory table with all source fields not stored in the Story table.

FIG. 3b shows the JustToday table of the editorial database, and its relationships to the Story table and other tables.

FIG. 3c shows the Story table of the editorial database, and its relationships to the Topic, Keyword, Kicker, Section, Town, Neighborhood, and StoryGroupings tables.

FIG. 3d shows the Story table of the editorial database, and its relationships to the Captions, Author, MultipleAuthor and Press tables.

FIG. 4 shows the template layout for the main news Web page including the text and Web link text areas.

FIG. 5 shows the template layout for the section news Web page including the text and Web link text areas.

FIG. 6 shows the template layout for the topic news Web page including the text and Web link text areas.

FIG. 7 shows the template layout for the story news Web page including the text and Web link text areas.

FIG. 8 shows the template layout for the classified search Web page including the text and Web link text areas.

FIG. 8a shows the template layout for the classified search response Web page including the text and Web link text areas.

FIG. 9 shows descending links from the main, section and topic news Web pages to section, topic, and story news Web pages.

FIG. 9a shows lateral links between section and section news Web pages, topic and topic news Web pages, and story and story news Web pages.

FIG. 9b. shows ascending links from story, topic and section news Web pages to topic, section and main news Web pages.

FIG. 10 shows the filtering process and its components.

FIG. 11 shows the publish process and its components.

FIG. 12 shows the editorial maintenance process in overview form, and its related files and programs.

FIG. 13 shows an overview of the interfaces of the editorial maintenance process.

Each of FIGS. 13a-13s shows a different one of the interfaces of the editorial maintenance process, and the tables in the editorial database it reads or modifies.

FIG. 14 shows the editorial archive process and its related files.

FIG. 15 shows the classified advertisement maintenance process and its related files.

FIG. 16 shows the death notice maintenance process and its related files.

FIG. 17 shows an overview of the interfaces of the news electronic mail maintenance process, and the tables and files it reads or modifies.

FIG. 18 shows the electronic mail process for news electronic mail.

### DETAILED DESCRIPTION OF INVENTION

Overview

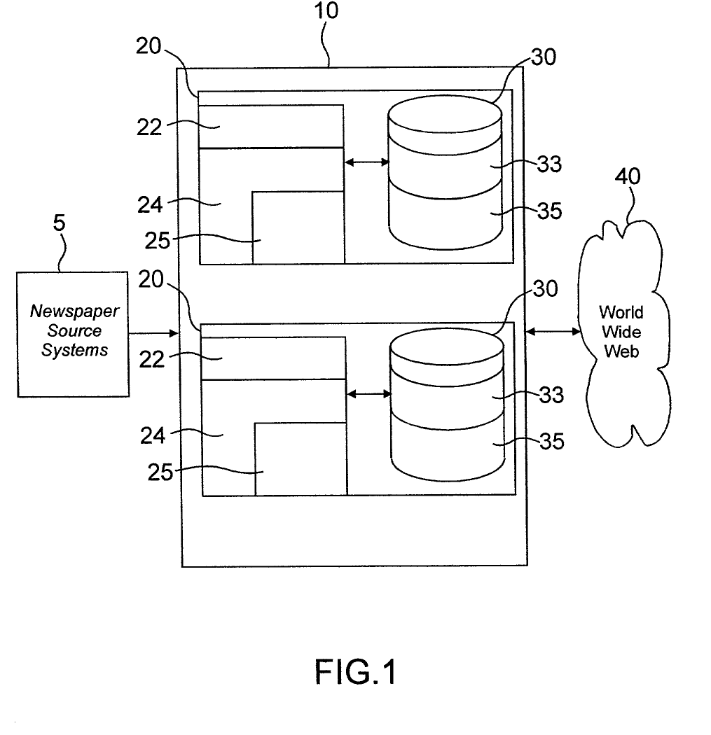

Refer first to FIG. 1. The invention is made up of a computer system 10 including one or more subsystems 20, each with its own processor 22, memory 24 and storage devices 30, a set of interrelated programs 25 which execute on computer system 10, an editorial database 33 residing on computer system 10, and a set of files 35 residing on computer system 10. The invention's computer system 10 is connected to the World Wide Web 40.

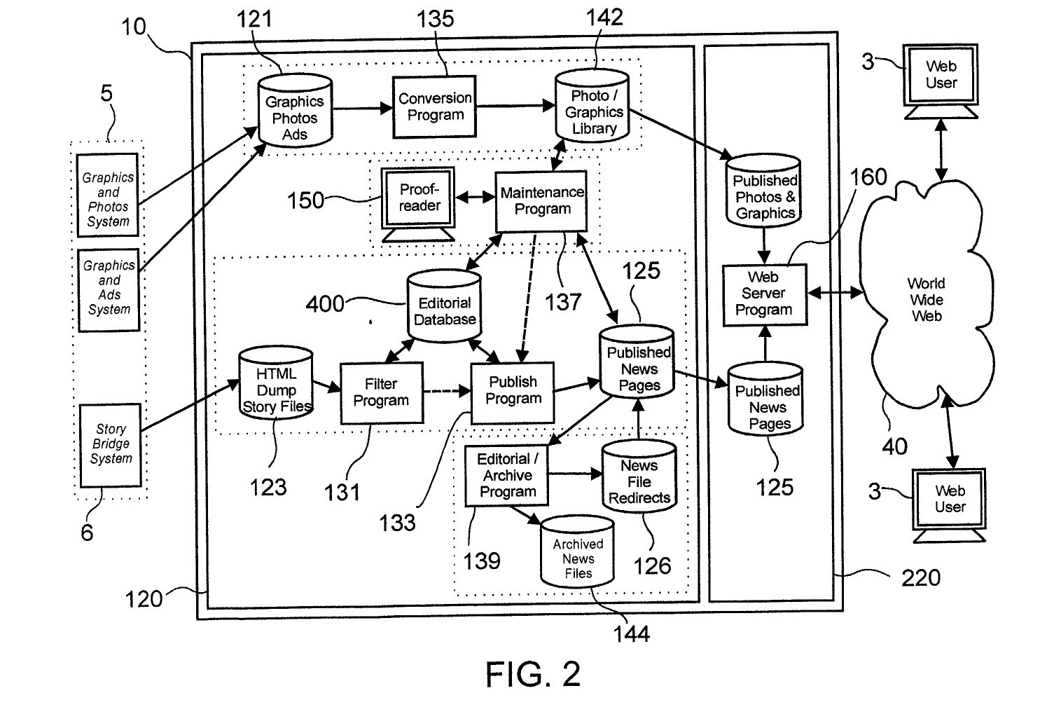

See FIG. 2. The invention's subsystems in computer system 10 include a maintenance Web server subsystem 120 and a public Web server 220. The inputs to the invention's processing programs in maintenance Web server subsystem 120 are the computer-stored input images 121 and story files 123. These files are created in the routine production of the daily printed newspaper, and originate on newspaper source systems 5. The input images 121, including news photos, advertising photos, and related graphics, arrive in a variety of electronic file formats. The electronic story files 123 arrive in a marked-up form as extracted from a pagination database on story bridge system 6. Each story file contains the text, headlines, authors, and press for a story, codes indicating the section of the newspaper in which the story belongs, the topic of the story, other story classification criteria, and editing markup codes for text size, font, and other text appearance characteristics.

The invention publishes the news on the World Wide Web using five separate programs. A filter program 131 extracts information in story files 123, stores the information in an editorial database 400, and starts a publishing program 133. Publishing program 133 retrieves story information from database 400 and produces a set of published news Web pages 125. Conversion program 135 converts input images 121 into images in a common format and stores the converted images in an image library 142. Maintenance program 137 is made up of a suite of maintenance Web pages. Maintenance program 137 retrieves published news Web pages 125 and enables a proofreader 150 to edit stories in database 400, link stories in database 400 with images in image library 142, and start publish program 133. Editorial archival program 139 selects published news Web pages 125 which have been displayed for a specified number of days, extracts information from these news Web pages, stores the information in news archive files 144, and replaces the extracted pages with pointers to an outside News Library source.

The paragraphs which follow describe the input files, the editorial database in which the data in the input files are stored, the news Web pages generated out of the editorial database, the templates used in the generation process, and the structure and linkage of the generated news Web pages.

Input Story Files

The primary input to the invention is the daily set of story files 123 produced in HTML dump format as a by-product from the process of publishing the printed newspaper. Each dump story file 123 contains the text of the story and a series of identifiably-marked data fields, called tags, containing classification and other descriptive information concerning that story. Many conventional style tags are not needed for Web editions of the newspaper. Although a dump story file 123 can be viewed as an HTML Web page, it lacks the formatting and linkage appropriate for easy Web reading. The invention's filter program 131 uses selected style tags to place the story correctly in the editorial database 400 and thus in the news Web pages 125. The selections and forms of tags are varied, and are described in the following section.

The Filter

Filter program 131 reads story files 123 one by one. Each story file 123 contains one or more text news stories. A news story may be a news story as marked up for printing in the newspaper, or it may be a caption as marked up for printing with a news picture, or it may be a portion of a news story marked up for printing. “Marked up” means that directions concerning story text formatting, story placement, and links to other stories and information are embedded in the story text itself. Such markup directions, also called “meta tags” or “style tags”, are identified by distinctive sequences of characters which delimit, or enclose, tags and values not a part of the story text. An example of a meta tag might be:

<!META NAME=”TOPIC:” CONTENT=”PICKS“>

where the opening “<“and the closing “>” signal to a program reading the story that one or more markup codes are enclosed. In this particular code, the word “NAME” before the “=” is a tag, used to assign a meaning to the value following the “=”, in this case “TOPIC:”. “CONTENT” is a second tag, associated with the value “PICKS “.

This particular combination of codes means that the name of a specific variable is “TOPIC”, and the value to be assigned to that variable is “PICKS”.

An example of a style tag might be:

“<!SII NAME=”SII.STYL.KEY”CONTENT=”[FT,h”> Headline text” where it signals to a program reading the story that one or more markup codes are enclosed. In this particular code, “[FT,h” denotes a headline tag. All data contained after this and before the next style tag is considered a headline to a story. There are various tags that denote different information.

Some style tags may appear in pairs, enclosing text and possibly other markup codes and style tags between them. For example, the tag “<HEAD>” begins a section of information that may include story text and other markup directions. The tag “</HEAD>”, including a “/” character just after the opening “<“ character, ends such a section.

A markup language is made up of an interrelated set of tags, such as meta and style tags, of different types. Different markup languages exist to serve different purposes. The most well-known markup language in use for constructing text-bearing Web pages is HTML, or Hyper-Text Markup Language. Other markup languages are used for formatting and structuring text and text content for printed media. Any file may contain tags from more than one markup language. While sensitive to certain specific tags from certain markup languages in a file, the invention may be easily adapted to process other tags in any markup language.

Each story file 123 contains large numbers of different style tags and codes. Writers and editors use software to direct the story's placement and formatting in its printed newspaper form. This software intersperses these style tags and codes in the story text to reflect editing changes and requirements. Consequently the inserted tags and codes appear in story files 123. For each story file 123, filter program 131 reads file 123 and removes all style tags not relevant to the creation of a Web version of the story. Filter program 131 also locates any picture caption related to the story, and creates a separate story out of the caption information, to be placed eventually with the picture on a Web page.

The Editorial Database

The invention's processing centers around editorial database 400. Editorial database 400 is a relational database residing on maintenance Web server system 120. The editorial database is accessed using a supporting database management system (DBMS). The editorial database is made up of a set of interrelated tables each having within it a set of records, also called rows. Each row in turn has within it a set of data elements, also called here columns or fields. Within a given table, all rows possess the same set of data elements, some or all of which may be populated with different data values. For each table a subset of data elements is identified which serves as a primary key for the table. A table's primary key identifies each one of its rows uniquely.

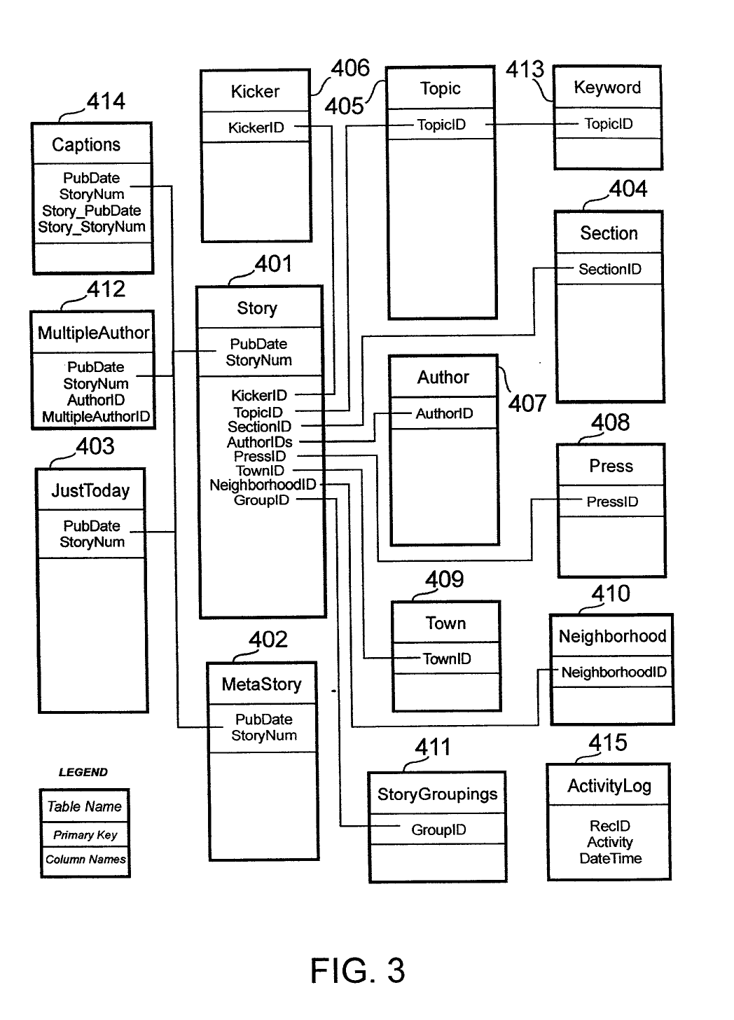

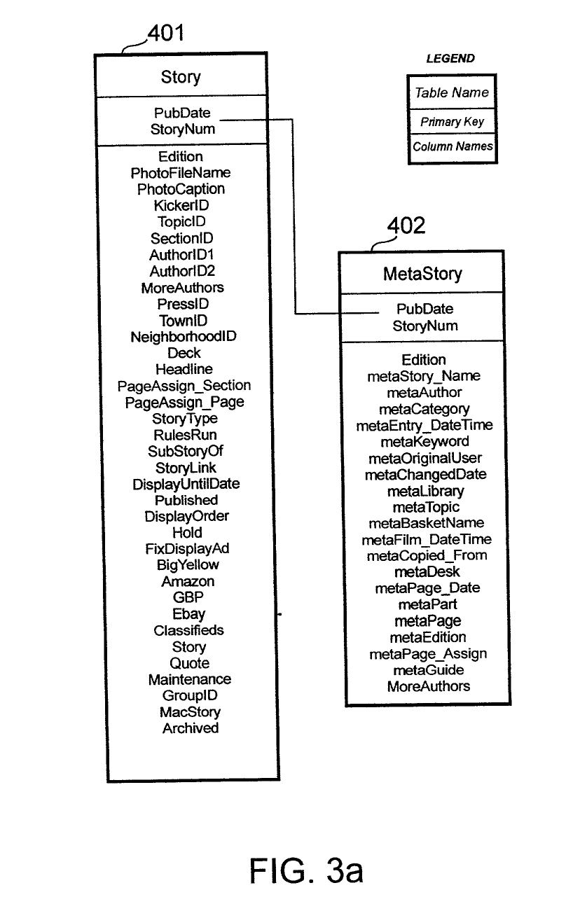

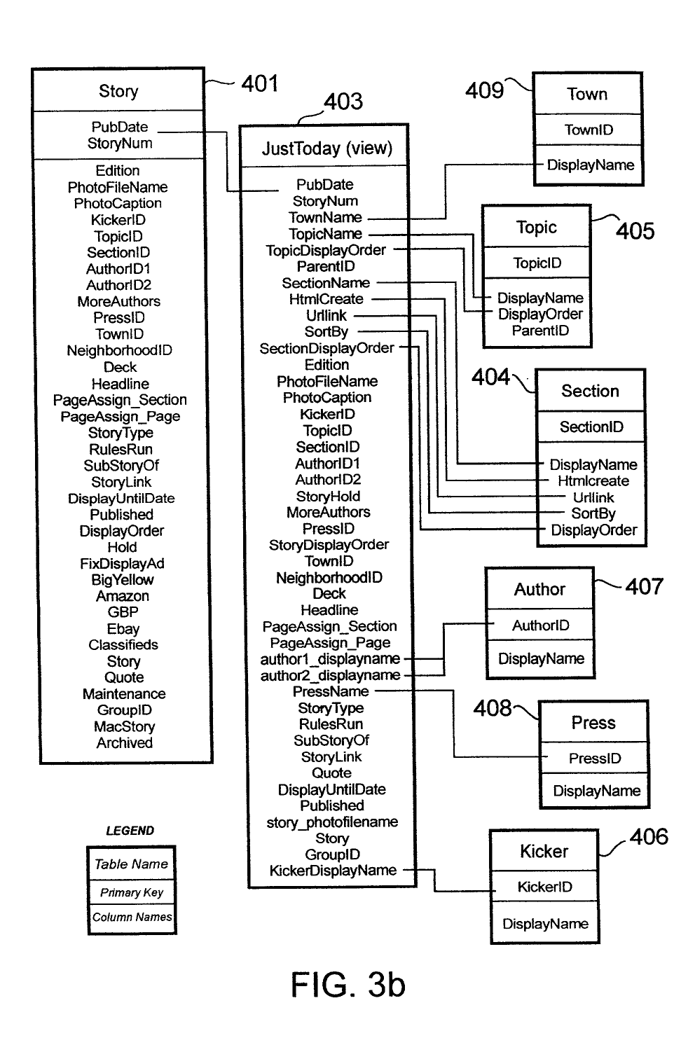

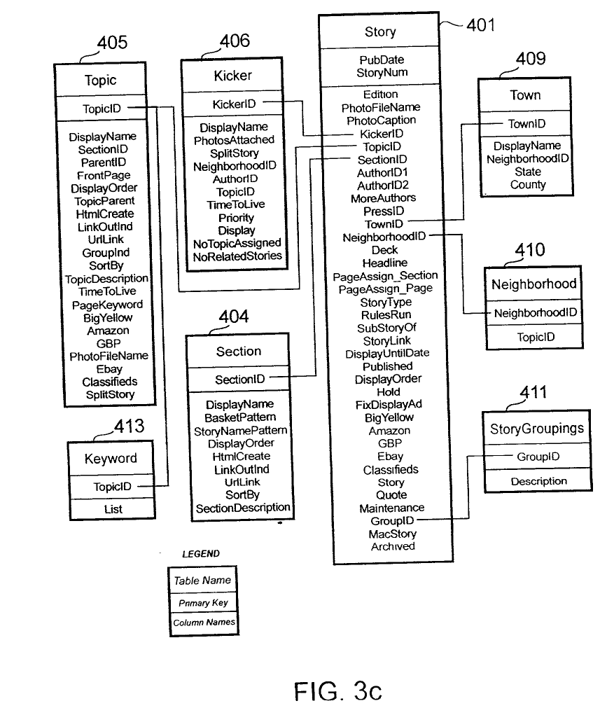

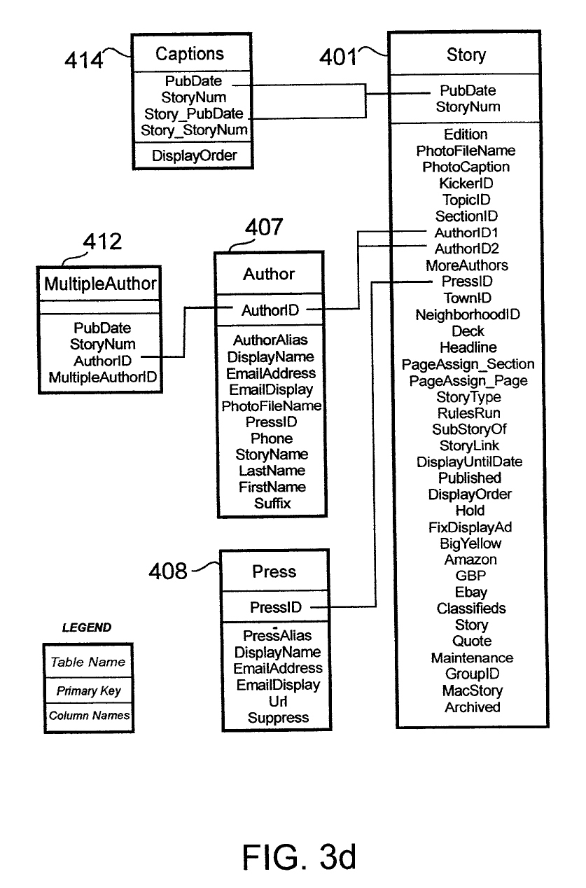

Refer to FIG. 3 for an overall view of the editorial database, its tables, and the principal relationships among them. Each relationship is shown as a line between a column named in a table and a primary key specified for another table. The stories from the newspaper are stored in editorial database 400 in component form. The stories to be displayed on the news Website are retrieved from editorial database 400 in an organization different from that of the source newspaper. Editorial database 400 has as its main component story table 401 which contains all story text and all organizational information for each story.

As shown in FIG. 3, certain data elements in story table 401 refer to other tables where additional information related to each such data element is stored. The story's author is stored in author table 407 with author-related information. Any additional authors for the story are stored in multiple author table 412. The press source for the story is stored in press table 408 with press-related data. The story kicker is placed in kicker table 406 with kicker-related data. The story's town is stored in town table 409 with related geographic data.

Two tables serve to provide the organizing “co-ordinates” for the story, fixing each story in a specific section of the Website under a specific topic. Each topic is a subclassification of a specific section. The section to which the story belongs appears in section table 404 with section-related information. The topic to which the story belongs appears in topic table 405 with topic-related information. Sections and topics are chosen and organized to mirror to any desired degree the choices and organization of the sections and topics of the printed newspaper produced from the same source information.

Story table 401 is also supported by captions table 414, keyword table 413, neighborhood table 410, and story groupings table 411. Captions table 414 is used for linking images and captions to news stories. Keyword table 413 is used for determining a story's topic based on keywords found in the story text. Story groupings table 411 is In used to place selected stories in a scrolling display area on the main news page, and to create two sports stories, ON-AIR and SPORTS TODAY, which can be viewed from the bottom of the Sports section page on the Website.

Editorial database 400 also incorporates tables which reduce database access overhead and simplify certain frequent accesses to the most recent news stories. A meta story table 402 contains style tags extracted from the stories in story files 123. Meta story table 402 data is used for historical purposes, and to reduce the size of each record in story table 401. A table view 403, showing the current news stories in table 401, holds all stories fromthe current publishing date. Activity log 415 is used by the filter program to direct updates either to the test Web site or the live Web site.

FIGS. 3a-3d show each table, its primary key columns, and the relationships among tables. As for FIG. 3, each relationship is shown as a line between a column named in a table and a primary key specified for another table.

FIG. 3a identifies the columns in story table 401 and meta story table 402. The combined contents ofthese two tables makes up the whole of story-based information for each story. The two tables are separated in order to reduce database access overhead during the publishing of the news on the Website. The columns in meta story table 402 are not used in the Web publishing process.

FIG. 3b shows the column composition of the view 403 of the current day's news stories. Columns from story table 401, town table 409, topic table 405, section table 404, author table 407, press table 408, and kicker table 406 are all joined for the current day's stories to produce view 403. Use of view 403 simplifies the programming and program operation when accessing the current day's news stories.

FIG. 3c identifies the columns in tables used in determining the topic and section assignment of a story. These include story table 401, section table 404, topic table 405, keyword table 413, kicker table 406, town table 409, neighborhood table 410, and story groupings table 411.

FIG. 3d identifies the columns in the remaining tables in editorial database 400. Shown here are captions table 414, author table 407, multiple authors table 412, and press table 408.

The invention also incorporates a classified advertisement and death notices database, made up of a classified ads table, a classified help wanted table, a help wanted keyword table, and a death notices table. These tables store all classified advertisements and death notices for display using the classified and death notice Web pages, and for reader search for specific classified advertisements or death notices.

The invention further incorporates an electronic mail notification database, made up of a subscribers table and an electronic mail table. These tables store subscriber and electronic mail information for readers who have chosen to have news in certain topics mailed directly to them electronically.

The invention's use of a relational database management system (RDBMS) provides for convenient changes to the editorial, classified, deaths, and other databases, such as addition and modification of tables, addition and modification of columns within tables, modification of relationships among columns and tables, and the combining or splitting of different sets of tables used in diverse applications. The set of tables, columns, and relationships presented here may be changed easily to meet new requirements and conditions of processing and presentation of the news Web pages. This flexibility constitutes a significant advantage of the invention over systems which do not employ RDBMS technology.

News Web Pages

As generated from the editorial database and a set of Web page templates, a single news Web page is made up of different regions, one of which shows a standard top of page, another a standard bottom of the page, a third the principal navigational links on the page, and a fourth region which may contain a single story, a list of stories, a formatted set of stories, a title, or a search form for use by the reader. Each story in turn includes a headline, a kicker, an author or authors, a press identifier, and possibly one or more cross-reference links to other stories. A news section or topic Web page may carry a story which is too long to fit in the space of that page, in which case that news Web page will display the leading part of the story and a link to the news story Web page containing the story. Each such link is a universal record locator (URL) as commonly used to permit a reader using the Web to change the display from one news Web page to another. The headline displayed for the leading part of a story incorporates a link to the complete text of that story.

News Web Page Templates

Each news Web page is constructed using a template. A template is a text file which includes text codes defining the formatting, content and operation of a specific region of the Web page, and includes markers identifying points and ranges in the template where information may be inserted, copied or deleted. As the templates are assembled by the Publish program, each template's contents are merged with story text, links, program codes, and formatting information to produce a functioning news Web page.

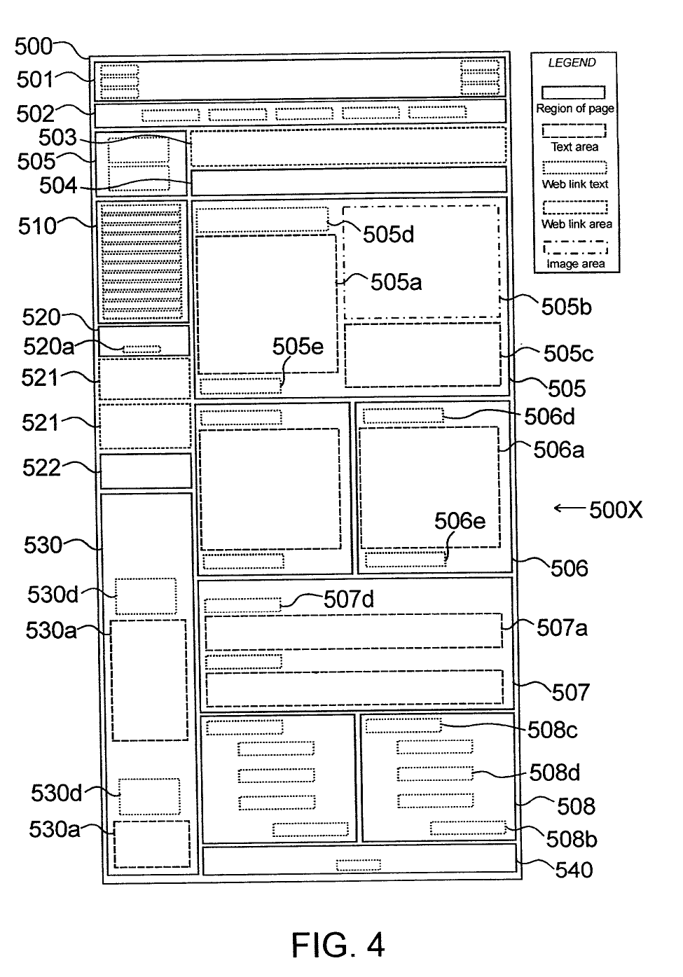

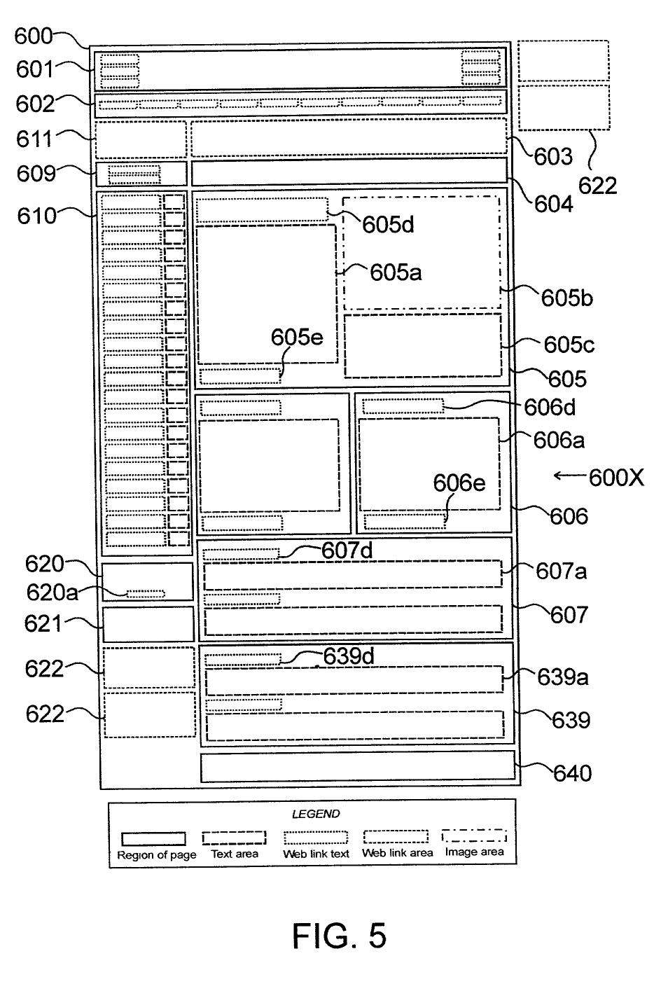

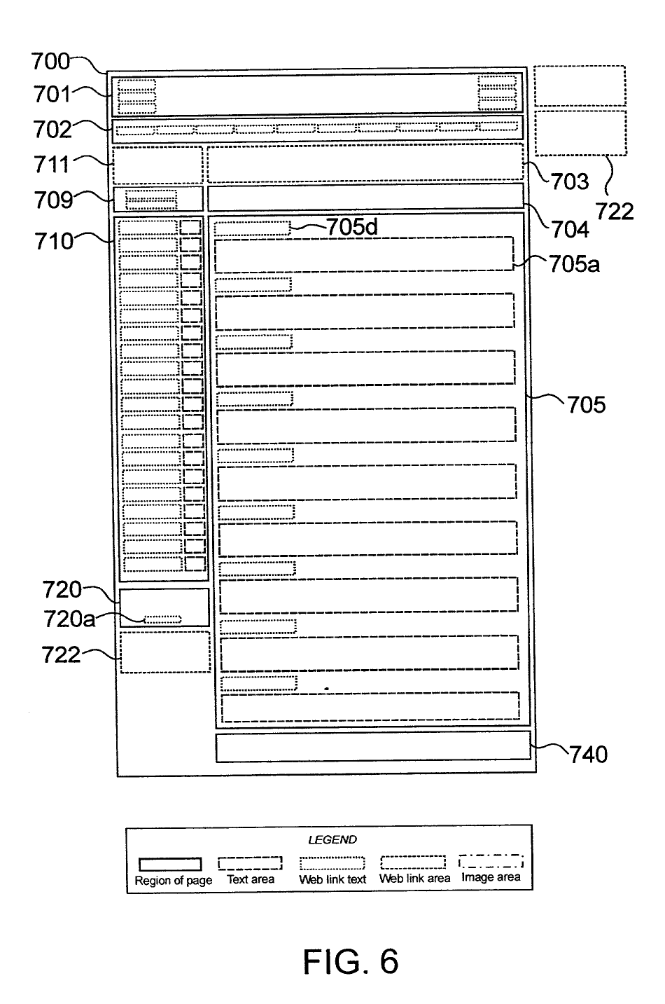

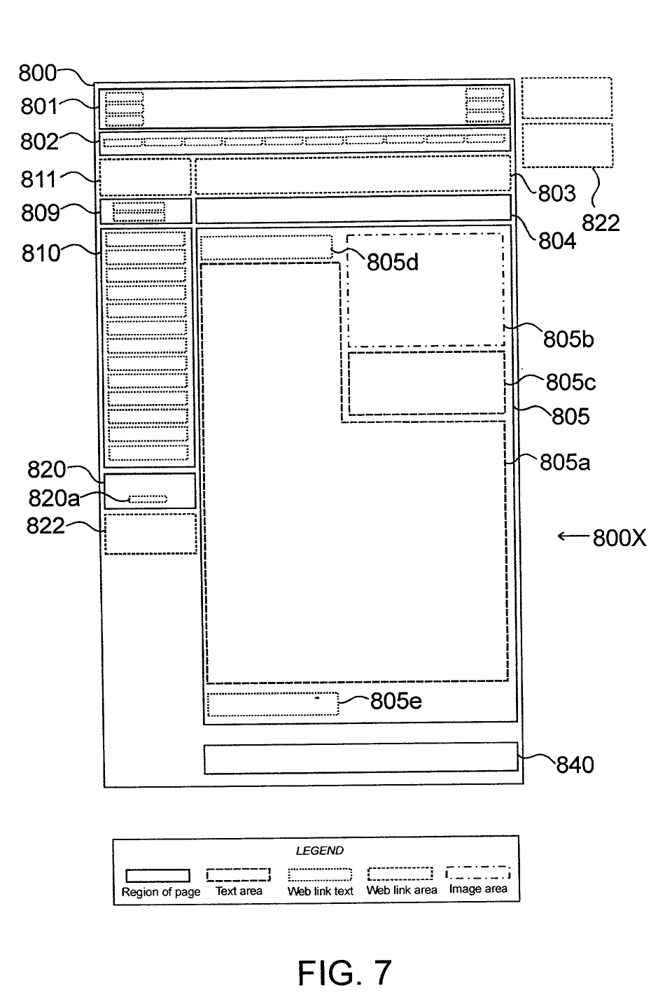

The invention's news Web page templates use four basic formats, shown in FIGS. 4, 5, 6, and 7. These figures are used to refer both to the empty templates before news information is added to them, and to the completed Web pages resulting from the addition of news information to the templates. As shown in FIG. 4, the main Web page template 500X is used to build the primary Web page 500 first seen when a reader enters the site using a Web browser. As shown in FIG. 5, the section Web page template 600X is used to build each of the section Web pages 600 first seen when a reader selects a section link for a section of the news such as “national/world”, “business”, or “sports” news. As shown in FIG. 6, the topic Web page template 700X is used to build each of the topic Web pages 700 first seen when a reader selects a topic link for a topic within a given section, e.g., “state”, “national”, or “international” within the “national/world” section. As shown in FIG. 7, the story Web page template 800X is used to build each of the story Web pages 800 first seen when a reader selects a story link.

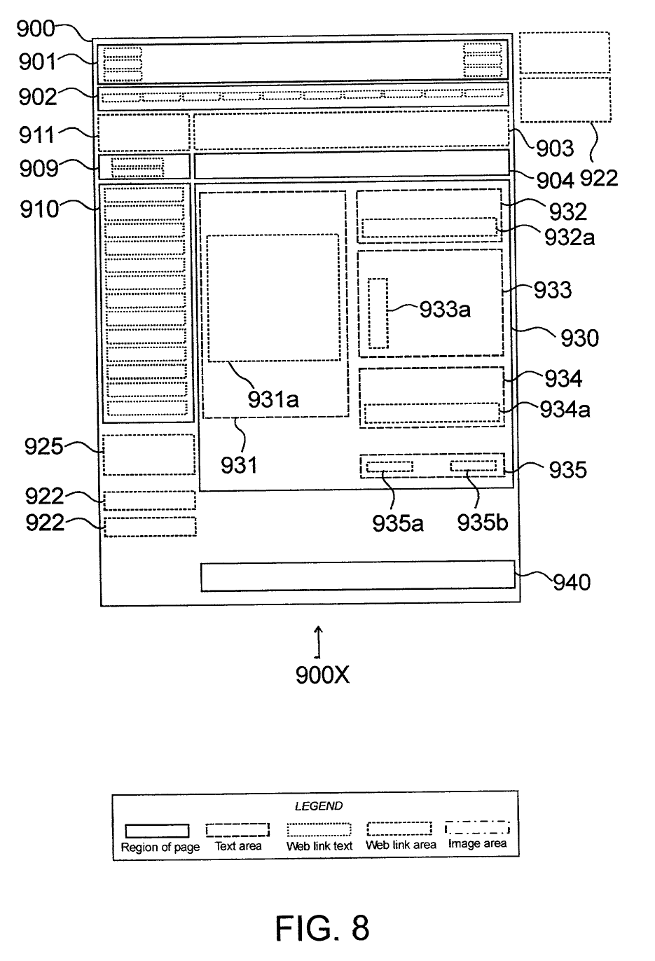

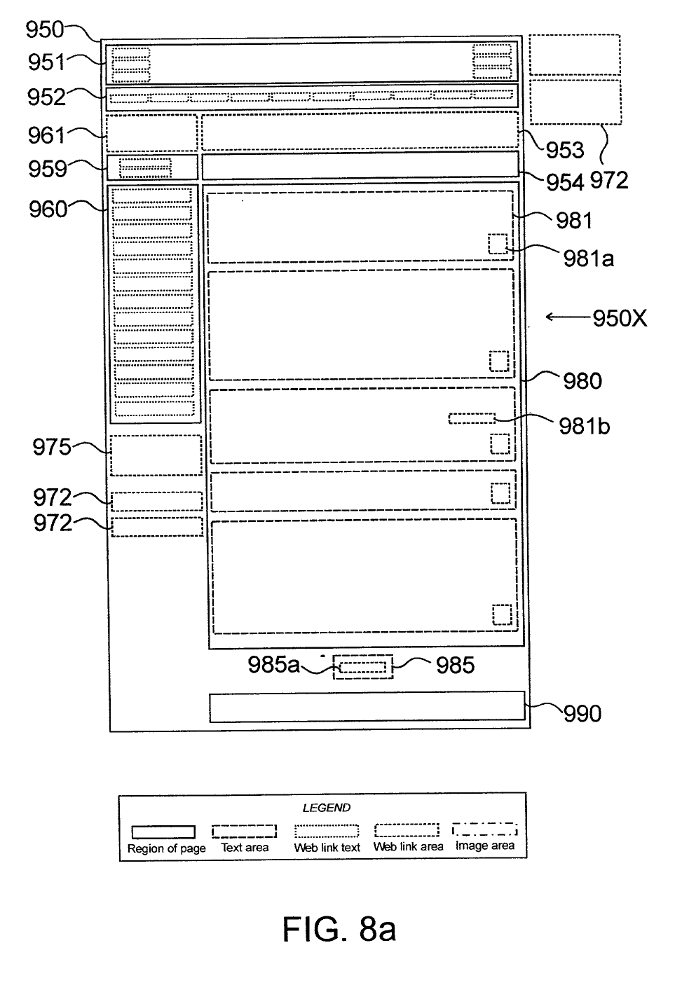

News on certain topics is generally presented in specialized formats customized conventionally for each topic. The invention incorporates a wide range of specialized templates to produce conventional Web page formats expected by readers. The invention's range of suchtemplates includes those forpages presenting sports box scores, sports league standings, movie reviews, travel, cartoons, bridal announcements, and entertainment listings and reviews. Additional Active Server Pages define the format, processing, and display of Web pages for classified listings, death notices, and news archive searches. Each of these news categories requires special formatting and display of its information, and the invention's templates meet their requirements without requiring significant programming effort. The diversity of design and content of templates is shown here via the set of classified advertisement search templates, shown in FIGS. 8 and 8a.

While FIGS. 4, 5, 6, 7, 8 and 8a show the layouts of the templates approximately as they might appear on a computer screen, the details of proportion, relative placement and sizing of regions, and contents and behavior of any region of any template may be easily modified by changes to the template itself, to the files loaded into the template, to the publish software that builds the Web pages, to the dynamic Web page code stored in the template or its supporting files, or to the HTML code stored in the template or its supporting files.

Story Web page templates take many forms distinguished primarily by the specialized formatting of their story text areas. The form variations include sports story templates such as: a news Web page template for presenting sports news stories, a baseball box score Web page template for displaying baseball box scores, a baseball leaders Web page template for displaying information on leading baseball teams, a baseball standings Web page template for displaying team standings of different baseball leagues, a football box score Web page template to show football box scores, and a football standings Web page template to show relative team standings in the football leagues.

Template form variations also include social story templates such as: a bridal Web page template for displaying wedding announcements and related information, an entertainment Web page template to display entertainment event announcements and entertainment sources, a movie reviews Web page template, a cartoon Web page template, and a travel Web page template for displaying travel stories and related information.

In addition, template form variations include such operational templates as an archival Web page template to allow a reader to be redirected to an outside source for news stories that have been archived. Also, those skilled in the art could use the filter and publish programs to produce news Web pages without templates.

News Web Page Structure

Refer now to FIG. 4. In appearance, the main Web page template 500X is divided into regions, populated with news data to produce a main Web page 500. First is a top region 501 identifying the source newspaper with a banner image and text, and displaying links to specialized Web pages including the news archives, the classified advertisements, the death announcements, a wire service page, a Website map page, and a page enabling the reader to prepare and send an electronic mail message to the sponsors of the Website. Next in order down the Web page is a region 502 carrying links to special sites and non-news Web pages of interest. A region 503 follows, containing a banner advertisement. Next is a series of news regions: a title region 504, a main region 505 displaying a lead story 505a with headline 505d, a lead story photograph 505b and caption 505c, a link 505e to the complete lead story, another main region 506 displaying the headlines 506d and leads 506a for other top stories, a farther main region 507 displaying the headlines 507d and leads 507a for other stories, and a further main region 508 displaying one or more links 508c to section Web pages and their stories. Section link region 510 contains a list of links to each of the different section Web pages. An additional region 530 displays news briefs in a scrolling region of the page. Several smaller regions display advertisements. Another region 520 displays a search input area 520a where the reader may request the Website to search through the news presentation for specific keywords. A bottom region 540 contains a copyright notice and a link to the top region of the page.

The principal effect of the display of the main Web page 500 is to give an online reader immediate access, to all sections of the news via links in region 510, to the most prominently-featured news stories, to a variety of advertising images and links, to all principal sections of the Website and related sites through links in regions 501 and 502.

In appearance, section and topic Web page templates are similar to each other. Both differ from the main Web page template in that the top region in both replaces the newspaper name and image with section names and images, and replace the main Web page's links to other sites with links to all section Web pages. Both section and topic Web page templates further differ from the main Web page template in that they replace the main Web page's links to all section Web pages with a set of links to all topic Web pages within the same section.

Refer to FIG. 5. The section Web page template 600X is populated with news data to produce section Web pages 600. A section Web page 600 presents headlines 605d, 606d, 607d, and 608d and first parts 605a, 606a, 607a, and 608a of top stories for the section including links to the complete stories, and navigation links to other Web pages. The section Web page template differs from the main Web page template in that its top region 601 replaces the newspaper name and image with section names and images, and its next region 602 replaces the main Web page's links to other sites with links to all section Web pages. The section Web page template further differs from the main Web page template in that it replaces region 510 containing the main Web page's links to all section Web pages with a region 610 containing a set of links to all topic Web pages within the same section. The section Web page also differs from the main Web page in that it contains no region analogous to region 508 displaying one or more links to section Web pages and their stories. The section Web page also differs from the main Web page in that it contains a region 609 displaying a link to the main Web page and a link to the section Web page itself.

The section template 600X closely resembles the main template 500X in that its top stories regions 605, 606 and 607 and their contents take the same form as regions 505, 506 and 507 respectively on the main Web page. The section Web page 600 also carries advertising in regions 603, 621, 622. As in main Web page 500, another region 620 displays a search input area 620a where the reader may request the Website to search through the news presentation for specific keywords. Region 639 contains links to On-Air and Sports Today stories. A bottom region 640 contains a copyright notice and a link to the top region of the page.

The principal effect of the display of a section Web page 600 is to give an online reader immediate access to all sections of the news via links in region 602, to all topics within the currently-displayed section via links in region 610, to the most prominently-featured news in the currently-displayed section, to a variety of advertising images and links, and to all principal sections of the Website and related sites through links in region 601.

As shown in FIG. 6, topic Web page template 700X is populated with news data to produce topic Web pages 700. A topic Web page 700 presents a region 705 containing headlines 705d and story openings 705a of all stories for the topic including links to the complete stories, and navigation links to other Web pages. This presentation of story headlines and openings is the principal difference between the topic Web page format and the formats of the main and section Web page templates. As in the case of the section Web page 600, the topic Web page 700 differs from the main Web page 500 in that its top region 701 replaces the newspaper name and image with section names and images, and replaces the main Web page's region 502 of links to other sites with a region 702 of links to all section Web pages. The topic Web page template further differs from the main Web page template in that it replaces the main Web page's region 510 of links to all section Web pages with a region 710 containing a set of links to all topic Web pages within the same section. The topic Web page also differs from the main Web page in that it contains a region 709 displaying a link to the main Web page and a link to the section Web page itself The topic Web page 700 also carries advertising in regions 703 and 722. As in main Web page 500, another region 720 displays a search input area 720a where the reader may request the Website to search through the news presentation for specific keywords. A bottom region 740 contains a copyright notice and a link to the top region of the page.

The principal effect of the display of a topic Web page 700 is to give an online reader immediate access to all sections of the news via links in region 702, to all topics within the currently-displayed section via links in region 710, to the complete list of news stories in the currently-displayed topic in region 705, to a variety of advertising images and links, and to all principal sections of the Website and related sites through links in region 701.

For story Web page template 800X, refer to FIG. 7. Story Web page template is populated with news data to produce story Web pages 800. A story Web page 800 presents a single complete story 805 together with optional links to related stories, and navigation links to other Web pages. Just as for the section and topic Web pages 600 and 700, the story Web page's top region 801 replaces the newspaper name and image with a section name and image, and replaces the main Web page's link region 502 to other sites with a region 802 containing links to all section Web pages. Like the section and topic Web page templates, the story Web page template differs from the main Web page template in that it replaces region 510 containing the main Web page's links to all section Web pages with a region 810 containing a set of links to all topic Web pages within the same section. The story Web page template also carries a region 809 containing specific links to its parent section and to the main Web page. The story Web page 800 also carries advertising in regions 803 and 822. As in main Web page 500, another region 820 116 displays a search input area 820a where the reader may request the Website to search through the news presentation for specific keywords. A bottom region 840 contains a copyright notice and a link to the top region of the page.

The principal effect of the display of a story Web page 800 is to give an online reader immediate access in region 805 to a single complete news story and its captions and pictures, to all sections of the news via links in region 802, to all topics within the currently-displayed section via links in region 810, to a variety of advertising images and links, and to all principal sections of the Website and related sites through links in top region 801.

For classified advertisement search Web page template 900X, refer to FIG. 8. This is the template for the Web page which appears when a topic or category is selected on the Classified main Web page. Classified advertisement search template 900X is populated with classified advertisement category information and related data to produce classified advertisement search Web pages 900. Classified advertisement Web page 900 contains a search input area 930, which in turn contains a search subcategory selection area 931, a keyword input area 932, a search parameter input area 933, a search results display sizing input area 934, and a search initiation input area 935. Classified advertisement Web page 900 also contains an advertisement selection link 925 providing the Web user with a means of displaying the set of classified advertisements the Web user has selected for responses to the advertisers.

Just as for the section, topic, and story Web pages 600, 700, and 800, the classified advertisement Web page's top region 901 replaces the newspaper name and image with a section name and image, and replaces the main Web page's link region 502 to other sites with a region 902 containing links to all section Web pages. Like the section, topic, and story Web page templates, the classified advertisement Web page template differs from the main Web page template in that it replaces region 510 containing the main Web page's links to all section Web pages with a region 910 containing a set of links to all topic Web pages within the same section. In the classified advertisement Web pages, the topic list in region 910 displays the set of possible search categories within the complete set of classified advertisements. The classified advertisement Web page template also carries a region 909 containing specific links to its parent section and to the main Web page. The classified advertisement Web page template 900 also carries advertising in regions 903 and 922. Finally, Web page template 900 displays a bottom region 940 containing copyright information.

See FIG. 8a. The results of a classified advertisement search are displayed using a classified advertisement search response Web page template 950X, which is populated with search responses in the form of classified advertisements to produce classified advertisement Web page 950. This search response Web page 950 is identical to the classified advertisement search Web page 900, except that it replaces the search parameter input area 930 with a search results display and selection area 980. In results display and selection area 980, all classified advertisements 981 matching the Web user's submitted criteria are displayed, each with a selection input area 981a. Selection input area 981a provides the Web user with a means of grouping the advertisements for viewing together. Some classified advertisements contain one or more links (URLs) 981b allowing the Web user to display a Web page containing more information on the advertisement.

The use of templates simplifies considerably the process of maintaining the Web pages and producing the overall news presentation on the Website. Presenting the news requires great flexibility in organizing and formatting the individual stories and the pages on which they appear. To present the news on a Website in a manner and appearance consistent with the paper form of the presentation (i.e., the printed newspaper) requires frequent customized adjustment and adaptation of the story text, links, program codes, and formatting information. Such changes must be done efficiently and accurately.

In a first embodiment, the invention assembles its templates into news Web page form using software programs written in a commonly-used high-level object-oriented programming language such as Visual Basic. The use of templates allows many such changes to be performed without changing software programs. A progranmner or other individual having to make changes to the format and organization of the news presentations on the news Website can do so by making a change to a marked-up template rather than to software program code. In a second embodiment, the invention eliminates the use oftemplates by simply embedding the template content in the software programs. The approach of the second embodiment requires that changes to news Web pages be accomplished by making program changes, and then testing and installing these changes to the Website software. Such a process consumes more time, costs more money, and presents more chance of error than the use of templates in the first embodiment. This difference confers a significant advantage on the invention's first embodiment using templates.

News Web Page Linkage

The organization and placement of news stories on the World Wide Web is of necessity different from their organization and placement in the printed newspaper. The reader of a printed newspaper may scan across large pages of print and images, skipping detailed text and articles of less interest, and may turn pages and fold the paper in the course of reading a story. By contrast, the reader of a Web newspaper views the news only through the screen window, and cannot scan multiple headlines quickly where they are dispersed among articles. Each page of a Web newspaper has limited room for story text. Finding topics and stories on the Web cannot be done the same way as with a printed newspaper. Navigating through the increased number of pages requires the addition of navigation aids for the computer user. Consequently the organization ofnews makes the printed form and the Web form of presentation differ sharply, both in their appearance and in their use.

A reader of a printed newspaper uses the physical newspaper's size and pagination, and its page and section references, to scan the headlines, follow the text of a given story, or select another story, topic or section to read. A Web-published newspaper lacks a large page size that can be easily scanned, but it offers the linking mechanisms of hypertext links (URLs) to let the reader do the same things. The invention provides a rich set of such links to help the reader of the news.

To provide navigation information for the reader to select different sections of the news to read, publish program 133 places a list of all sections in the main, section, topic, and story Web pages. Each list entry incorporates a URL for a different section Web page. Likewise, to provide navigation information for the reader to select different topics of thenews to readwithin a section, publish program 133 places alist of alltopics, with a link to the topic Web page for each topic, in the section, topic, and story Web pages. Each list entry incorporates a URL for a different topic Web page. Finally, some topics are further broken down into subtopics. For each ofthese topics, publish program 133 replaces the list of topics in the section with a list of all subtopics within the topic. The UTRL incorporated in each entry in these lists points to a different subtopic Web page. The same list of subtopics that appears on a topic Web page appears on the Web page for each of its subtopics. In its overall format, a subtopic Web page is substantially identical to a topic Web page.

Once prepared for the current day's news presentation, the different types of Web pages produced from the templates are linked together to provide the reader with extensive navigation choices. Some links descend from the main news Web page through the other types of news Web page. Other links laterally connect news Web pages of the same type. Still more links ascend from the story Web pages up through to the main news Web page.

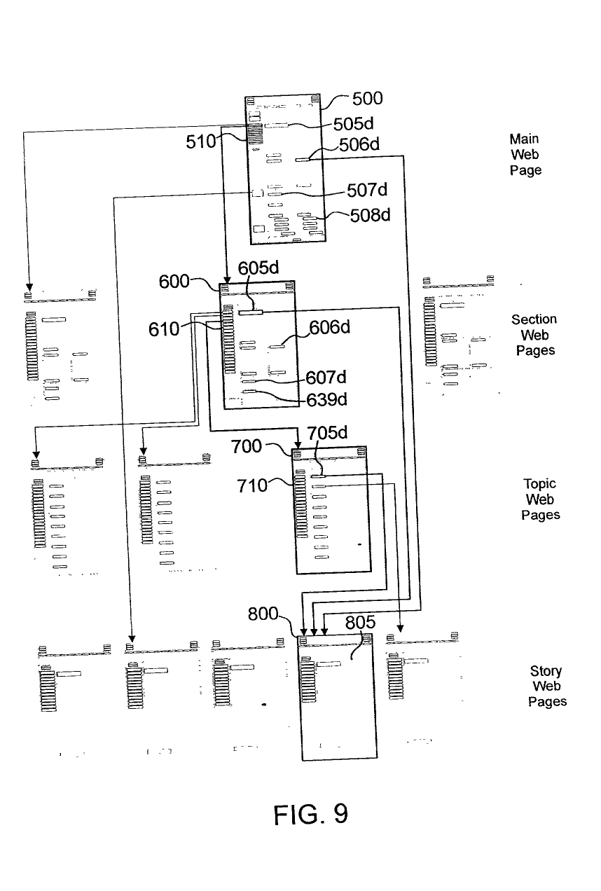

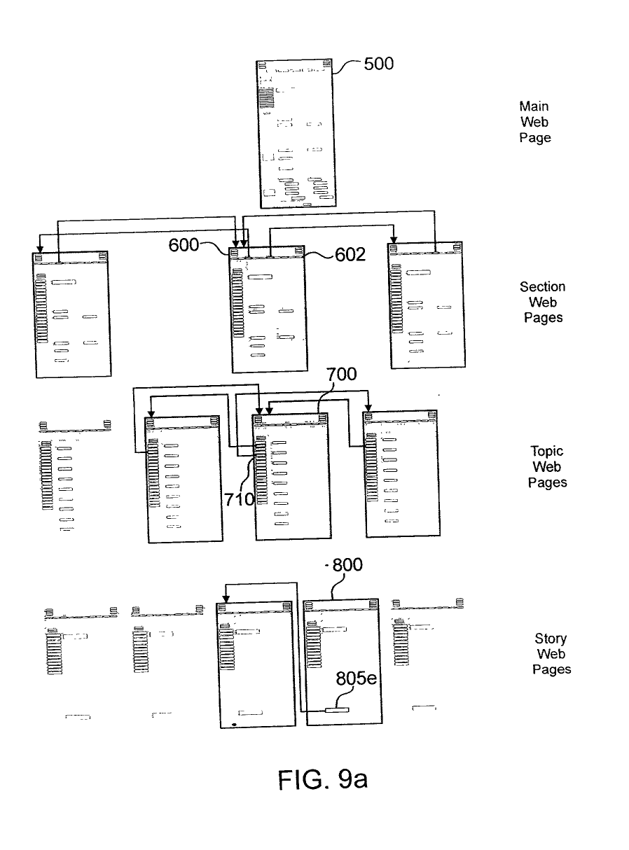

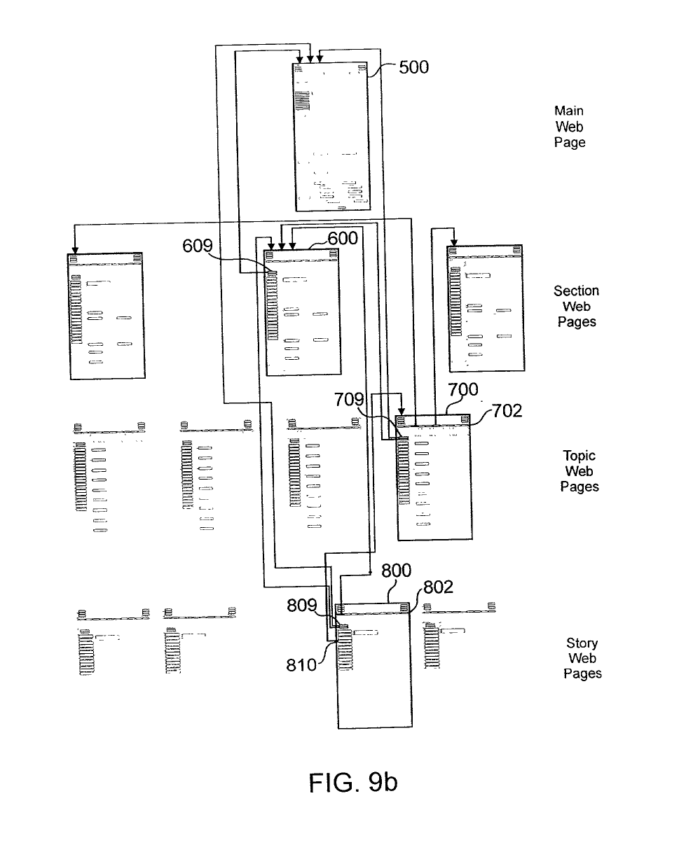

Refer now to FIG. 9, which shows the flow of links downward, starting with the main Web page at the top, as descending arrows. The main Web page 500 contains links, or URLs, in region 510 pointing to a section Web page for each section Web page 600 of the news presentation, and links 505d, 506d, 507d, 508d pointing to a story Web page 800 for each story featured on the main Web page. Each section Web page 600 in turn contains links pointing to a topic Web page 700 for each topic within that section, and links 605d, 606d, 607d pointing to a story Web page 800 for each story featured on that section Web page 600. Each topic Web page 700 in turn contains links 705d pointing to a story Web page 800 for each story featured on that topic Web page.

Refer now to FIG. 9a, which shows the flow of links between Web pages of the same type as lateral arrows. Each section Web page 600 contains links in region 601 pointing to each other section Web page 600. Each topic Web page 700 contains links in region 710 pointing to each other topic Web page 700 within the same section. If a topic has subtopics, each subtopic has its own topic Web page, and its links in region 710 to other topics are to the topic Web pages 700 for the subtopics within the same parent topic. Some story Web pages carry links to other story Web pages, for related stories.

Refer now to FIG. 9b, which shows the flow of Web page links upward, starting with story Web pages 800 at the bottom, as ascending arrows. All story Web pages 800 contain links in region 810 pointing to a topic Web page 700 for each topic within the same section as the story, links in region 809 pointing to the story's parent section 600 and the main Web page 500, and links in region 801 pointing to all sections of the news presentation. Topic Web pages 700 in turn contain links in region 701 pointing to all sections of the news presentation, and links in region 709 pointing to the story's parent section 600 and the main Web page 500. Section Web pages 600 in turn contain links in region 609 pointing to the main Web page 500.

In addition to the links and categories of links listed above, any Web page may contain additionallinks to othertopic Web pages 700, other section Web pages 600, other story Web pages 800, or Web pages from other Web sites as specified in the template.

The invention's use oftemplates and dynamic Web pages provides for responsive, flexible, timely news presentation with a minimum of software design, development and testing. The set of templates and dynamic Web pages presented here may be changed easily to meet new requirements and conditions of processing and presentation of the news Web pages. This flexibility constitutes a significant advantage of the invention over systems which do not employ dynamic Web page technology.

### OPERATION OF INVENTION

Overview

The invention's principal purpose is to present newspaper content on the World Wide Web for Web users, in a form most suitable for use on a computer connected to the World Wide Web. See FIG. 2 for the primary pathways of operation which fulfill this purpose. The invention reads news text input in the form of HTML dump story files 123, inserts them into editorial database 400 using filter program 131, provides test site access via maintenance program 137 for a proofreader 150 to apply edits and corrections to the editorial database, and publishes the news from the database onto news pages 125 using publish program 133. Other processing pathways support the text news, specifically the processing of input graphics and photos 121, shown in FIG. 2, and the processing of classified advertisements and death notices, not shown in this figure. Still other processing pathways, also not shown in this figure, prepare and send electronic mail with news items and links to subscribed Web users. The following sections describe the processing performed in presenting the news to the Web users.

The Filter Process

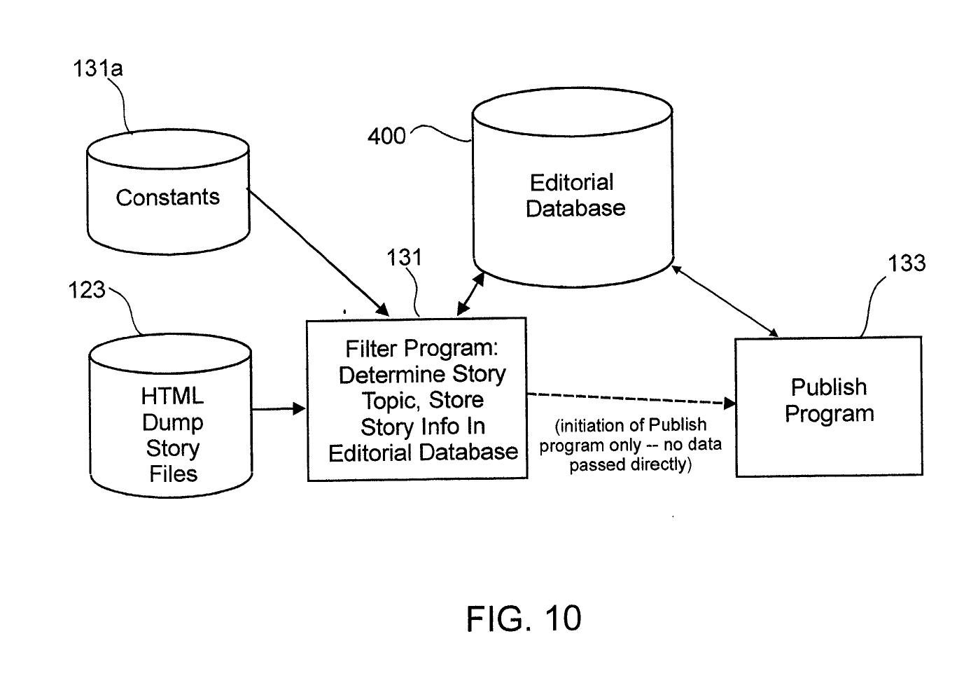

Filter program 131 is executed every hour. It translates text and style tags in each incoming story file into the text and codes required to organize, format and present the same story on the World Wide Web. Conventional news stories include numerous style tags that are superfluous for Web pages. The filter program 131 separates the useful style tags from the superfluous tags. The filter program then stores each story and its codes in the editorial database 400. Refer to FIG. 10. Filter program 131 first reads a stored set of constant values 131a used in locating files and databases, setting size limits to data elements and lists of internal data, specifying time and time interval limits, defining lists of valid values for table entries, and specifying any other parameters and parameter values. The contents of set 131a may vary from one execution of filter program 131 to another execution at another time. Changing the contents of set of constant values 131a changes inputs, operation, and outputs of filter program 131.

Each story file 123 contains large numbers of different style tags and codes. These style tags and codes were previously interspersed in the story text by software the writer or an editor uses in order to direct the story's placement and formatting in its printed newspaper form. First, for each story file 123, filter program 131 reads file 123 and removes all style tags not relevant to the creation of a Web version of the story. Filter program 131 also locates any picture caption related to the story, and creates a separate story out of the caption information, to be placed eventually with the picture on a Web page.

Filter program 131 stores each text news story in the editorial database with all the information needed to place it and present it properly on the Website. To obtain this information, the filter program 131 parses the story text to extract, translate and store in editorial database 400 the story's topic, section, kicker, press source, author, headline, sub-headline, geographical placement, keywords, basket, deck, and any other classification information useful in placing the story on the Website. The parsing, extraction and storage processes are performed using techniques familiar to those versed in the art of computer programming.

The topic of a story determines a story's placement on the Website. Determination of a topic is consequently the most important issue in preparing the story for storage in the editorial database and later publishing of the story on the Website. To determine the Website topic of a story for the Website, filter program 131 uses the style tags for the edition, story name, page assigned, basket, topic, keyword, guide, library, author, and story number as supplied in the input story file 123. Program 131 then tests combinations of these style tags to establish a value for the topic as required for the Website. If these combinations fail to yield a valid topic, program 131 then uses the story's kicker as the topic, if the kicker exists. If the topic is still unassigned, program 131 then tries to find a town name that matches the story's town, and assign the town's topic to the story.

If no topic is assigned by any of the above processes, program 131 then attempts to match keywords in the story to keywords listed for each known topic. Program 131 weights its matches according to whether a match was found in the headline, the kicker, the deck or the body of the story, and assigns the topic on the basis of the best weighted keyword match.

This topic assignment process may take one of several forms. In a first embodiment, a story's topic and other similar data element values are determined by programming language code which performs the tests of combinations of input style tags to arrive at a topic value.

In another embodiment of the invention's translation process, the story's topic and other similar data element values are determined by the application of a set of tabulated rules to test the style tag combinations. In still another embodiment, the story's topic and other similar data element values are determined by programmed rules supported by a rule-based expert progranmming system, again applied to testing the style tag combinations. In all embodiments, making changes to the set of rules or program code is limited to changing simple tests and test combinations, and changing the actions that are determined by the results of those tests.

Using the extracted data elements, filter program 131 stores the story in story table 401 in editorial database 400. Filter program 131 also stores the story's author in author table 407, any additional authors in multiple author table 412, the press source in press table 408, the kicker into kicker table 406, the section into section table 404, and the town into town table 409. To provide audit access to input data elements used in its topic selection process, filter program 131 stores the data elements extracted from story file 123 in meta story table 402. When filter program 131 has finished processing story files, the editorial database contains all stories created since the previous execution of the filter program. Filter program 131 then generates a new version of the just today view 403, combines certain stories, marks duplicate stories as held so that they will not appear, and marks area brief stories and some sports stories as grouped for appearance in scrolling regions of Web pages. Filter program 131 then initiates execution of publish program 133, and exits. Filter program 131 passes no data directly to publish program 133.

The Graphics Conversion Process

To be published on the World Wide Web, image files must be converted into a common format. Refer again to FIG. 2. Conversion program 135 reads input graphics, including news photos, advertisements, and other visual display files 121, determines the electronic file format of each file, converts the input file into a graphics file in a common format using commonly-understood methods, and stores the input file in a photo and graphic image library 142. Publish program 133 links its published news pages 125 to files in graphic image library 142. Editorial maintenance program 137 provides for a proofreader to link files in graphic image library 142 to published news pages 125 by creating references in editorial database 400 between stories and their respective graphics images.

The Publish Process

The publish program is started either by a message sent from the filter program, or by a command sent by a proofreader using an editorial maintenance program. The publish program retrieves stories from the editorial database and produces a set of linked news Web pages containing all the news stories within the range of dates displayable as current. Based on information extracted from the input story text files and stored in the database, the stories displayed on the news Website are arranged in an order that parallels closely the order of the appearance of the stories in the printed newspaper. The publish program stores the newly-produced news Web pages either on the publicly-accessible news Website or on a test news Website for use by the proofreader. The publicly-accessible news Website is updated once a day, or as often as required by changes in news input. The test news Website is updated as often as required by the proofreader.

In general, a Web page resides on a server computer system on the World Wide Web. When a reader with a client computer system wants to read the Web page, the reader sends a command to the server system storing the Web page. The server system then sends the Web page to the reader's client system, where it is stored and displayed to the reader. Some Web pages are constructed with program components incorporated in them. Some Web page program components are marked to be processed on the server computer system, in order to update the Web page with current information available on the server computer systembefore sending the page to the client system. Other Web page program components are marked to be processed on the client computer system, in order to adapt the display to the requirements of the browser program and client computer system used by the reader, and to update the Web page with current information available on the client computer system. The Web pages created and supported by the present invention carry both server-processed and client-processed program components as required.

As an overall example of this process, the program source code for a template may be a text file containing ordinary text, HTML (Hypertext Markup Language) markup directives and program code, dynamic Web page markup directives and program code, and template directives. The template directives provide markers for the insertion, copying, or deletion oftext, HTML directives and program code, and dynamic Web page directives and program code in the Web page derived from the template. The publish program uses template directives to fill in the template with specific news information to be displayed to readers at the Website. The publish program then stores the filled-in template as a news Web page. This is the end of the publish program's task.

The dynamic Web page directives, including program code, are processed by the news Web server when the filled-in template, now a news Web page in Active Server Page form, is prepared for transmission to the reader. The HTML directives, including program code, are processedbythe reader's client computer systemwhen the transmitted Web page is received there. The invention's use of templates permits fast, easy changes to dynamic Web page directives and code, and HTML directives and code, without modifying the publish program's program code. This provision for quick, simple changes allows significant variability in the appearance and behavior of the Web page as seen by the reader. This provision constitutes a significant advantage over other methods of Web page maintenance and improvement.

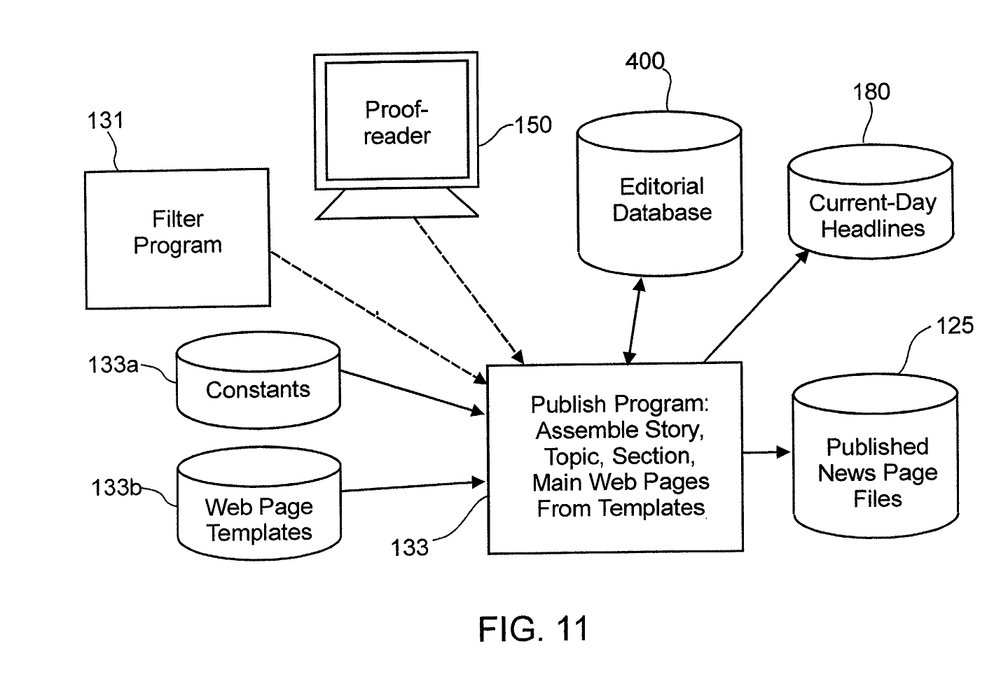

Refer now to FIG. 11. Publish program 133 first reads a stored set of constant values 133a used in locating files and databases and specifying any other parameters and parameter values which may vary from one execution of publish program 133 to another execution at another time. Publish program 133 reads editorial database 400 and selects from story table 401 all stories which have not already been published and which are not marked to be held back from publication. For each story, program 133 also selects from topic table 405, section table 404, kicker table 406, author table 407, and press table 408 all information related to each story for each respective table. Program 133 uses the retrieved topic name of each story to select a type of template and create a story template copy 800X for presentation of that story.

Publish program 133 then begins expansion of template 800X into a story news Web page 800. Refer also to FIG. 7 for story news Web page details. First, program 133 installs navigation information in regions 801, 802, 810 of Web page 800. Navigation information is a collection of URLs each of which provide the reader of the news Web page with a link to other news Web pages. See the previous sections of this specification titled Web Page Structure and Web Page Linkage for a detailed discussion of link content and arrangement.

Publish program 133 then builds story content into Web page 800, including kicker, topic, authors, press identification, story date, author photo, story photo 805b, story photo caption 805c, storytext 805a, headline 805d, andlinks 805eto related stories, as any or all may exist. Once this stage is complete, program 133 marks the story in story table 401 in editorial database 400 as published. This step completes the preparation of a story Web page from the story Web page template.

In the next step, the publish program 133 builds the main Web page 500 from template 500X. To provide navigation information for the reader to select a section of the news to read, publish program 133 places a list of all sections, with a link to the section Web page for each section, in the main Web page template 500X in region 510. Based on the display ordering information stored in editorial database 400 for each story, program 133 then selects the top stories from the current day for display on the main Web page 500, and builds headings 505d, 506d, 507d containing URLs and partial story information 505a, 506a, 507a into main Web page 500 for each of the selected stories. Headings 505d, 506d, 507d contain URLs that point to the respective complete stories. In order to facilitate further reading for the top three selected stories, program 133 also incorporates URLs 505e, 506e pointing to the story Web pages 800 holding the complete stories. Publish program 133 also installs in template 500X any banner advertisements 503, 521 for display on main Web page 500. For the top story, program 133 builds into main Web page 500 a caption 505c for the story's picture 505b.

For certain sections 508c of the news, program 133 selects top stories and appends their headlines 508d to the main Web page 500 in region 508. In order to facilitate reading of the body of the story, program 133 incorporates a URL for each headline pointing to the story Web page.

Certain stories are grouped for treatment as area news briefs on the main Web page 500. Publish program 133 concatenates and edits stories in such a group into news briefs 530a with headlines 530d that incorporate hypertext links to the stories, in a single revolving text stream for display in a scrolling region 530 on the main Web page. This step completes the preparation of the main Web page 500 from the main Web page template 500X.

Next, for each section and topic, publish program 133 prepares section and topic Web pages 600 and 700, using the section and topic Web page templates 600X and 700X respectively.

In the next step, the publish program 133 builds the section Web page 600 from template 600X. To provide navigation information for the reader to select a section of the news to read, publish program 133 places a list of all sections, with a link to the section Web page for each section, in region 602 of the section Web page template. Based on the display ordering information stored in editorial database 400 for each story, program 133 then selects the section's top stories from the current day for display on the section Web page 600, and builds headings 605d, 606d, 607d containing story page URLs and partial story information 605a, 606a, 607a into the section Web page template 600X for each of the selected stories. In order to facilitate further reading for the section's top three selected stories, program 133 also incorporates URLs 605e, 606e pointing to the story Web pages holding the complete stories. Publish program 133 also installs in template 600X any banner advertisements 603, 621, 622, 623 for display on the section Web page 600. For the section's top story 605a, program 133 builds into template 600X a caption 605c for the story's picture 605b.

In the next step, the publish program 133 builds the topic Web page 700 from template 700X. To provide navigation information for the reader to select a section of the news to read, publish program 133 places a list of all sections, with a link to the section Web page for each section, in region 702 of the topic Web page 700. Based on the display ordering information stored in editorial database 400 for each story, program 133 then orders the topic's top stories from the current day for display on the topic Web page 700, and builds headlines 705d and partial story information 705a into the topic Web page template 700X for all stories in the topic. In order to facilitate further reading for each one of the topic's stories, program 133 also incorporates in headline 705d a URL pointing to the story Web page holding the complete story. Publish program 133 also installs in template 700X any banner advertisements 703 and 722 for display on the topic Web page 700.

As prepared by publish program 133, a story may appear in multiple places at once. It may display in abbreviated formn on the main Web page 500, a section Web page 600, and a topic Web page 700, and in complete form on its own story Web page 800. Each story will appear at least on a topic Web page 700 in abbreviated form and on its own story Web page 800 in a complete form. Some stories will appear also on a section Web page 600. A few stories will appear also on both a section Web page 600 and the main Web page 500. The multiple appearances of a story simplify the reader's task in locating story details, regardless of the Web page currently being displayed to the reader.

When publish program 133 has created a news Web page, it stores the newly-created Web page as a file in the collection of published news Web page files 125.

In the course of creating the news Web pages, publish program 133 also constructs and stores a set of headlines 180 for the main Web page, each section Web page, and each topic Web page. Set of headlines 180 is used in later processing by the news electronic mail program to inform subscribing users of selected news via electronic mail.

The Editorial Maintenance Process

To facilitate changes in each day's news presentation, the invention provides a Website interface for use by a proofreader. The interface is made up of a set of Web pages each of which provides the proofreader with a method of changing a specific set of data values in the editorial database, and of selecting and linking image files and their captions with the stories to which the images and captions apply. The invention also provides an offline protected Website to allow the proofreader to view any such changes as news Web pages before they are committed to the Website accessible to the general readership. The invention further provides a program which publishes the news to the generally-accessible Website or to the offline protected Website. The collection of these programs is called here the editorial maintenance program.

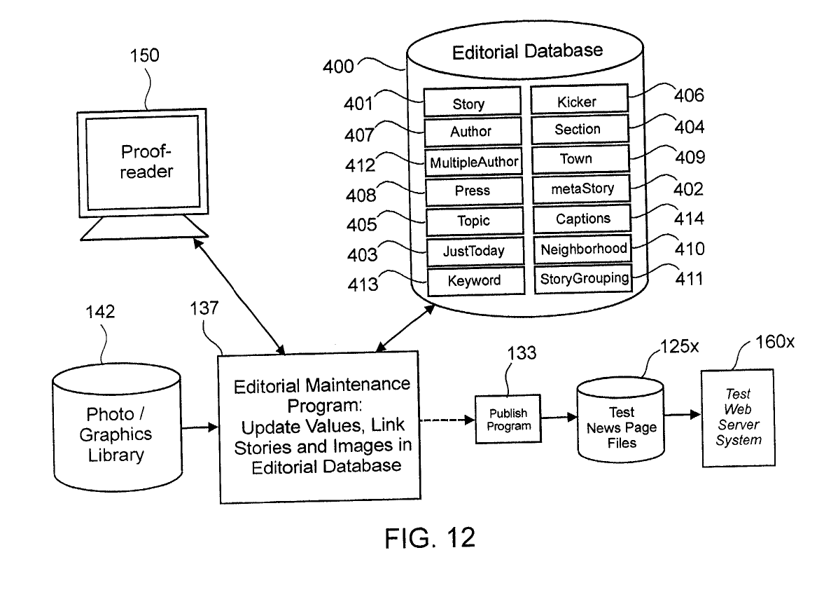

Refer first to FIG. 12. for an overview of the editorial maintenance process. Editorial maintenance program 137 is made up of a set of independent maintenance Web pages. Each maintenance Web page provides proofreader 150 with a means of updating a specific set of values in editorial database 400, or of initiating execution of publish program 133. Among the values to be updated are the links from specific stories in the database to specific graphics files in photo and graphic image library 142. Initiation of publish program 133 provides for either the creation of a set of news Web pages 125 to be displayed publicly for readers on news Web server 160, or the creation of a set of test news Web pages 125X to be stored on test Web server system 160x. Creation of test news Web pages 125X allows proofreader 150 to preview the results before making published news Web pages 125 available openly on news Web server 160.

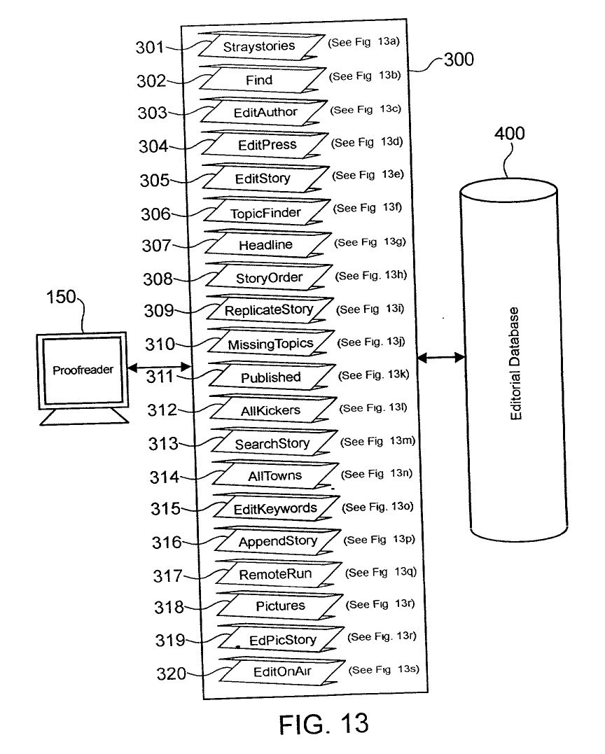

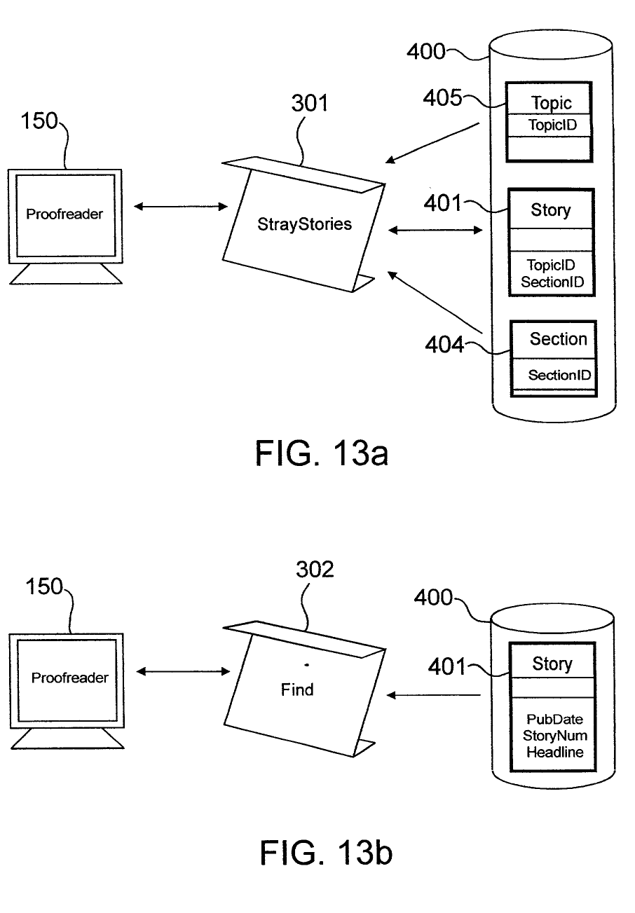

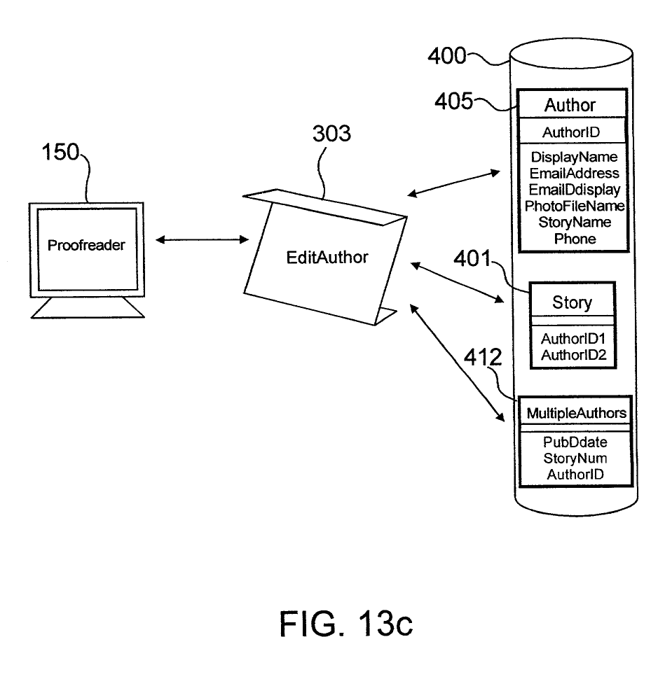

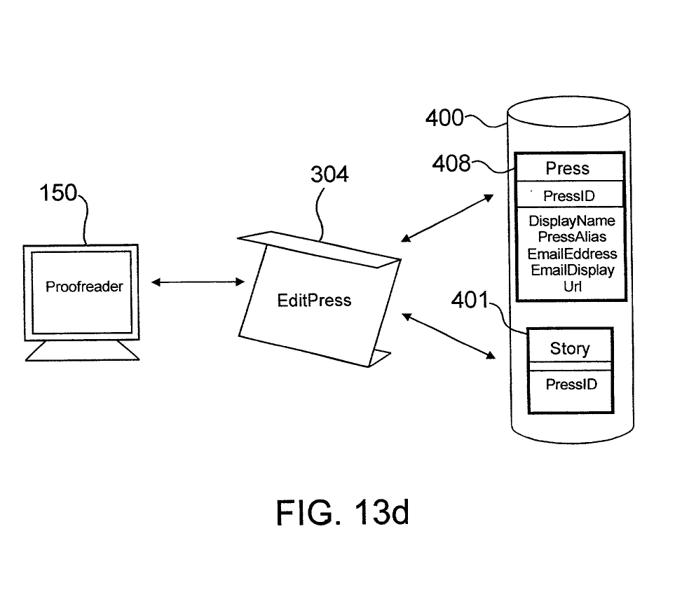

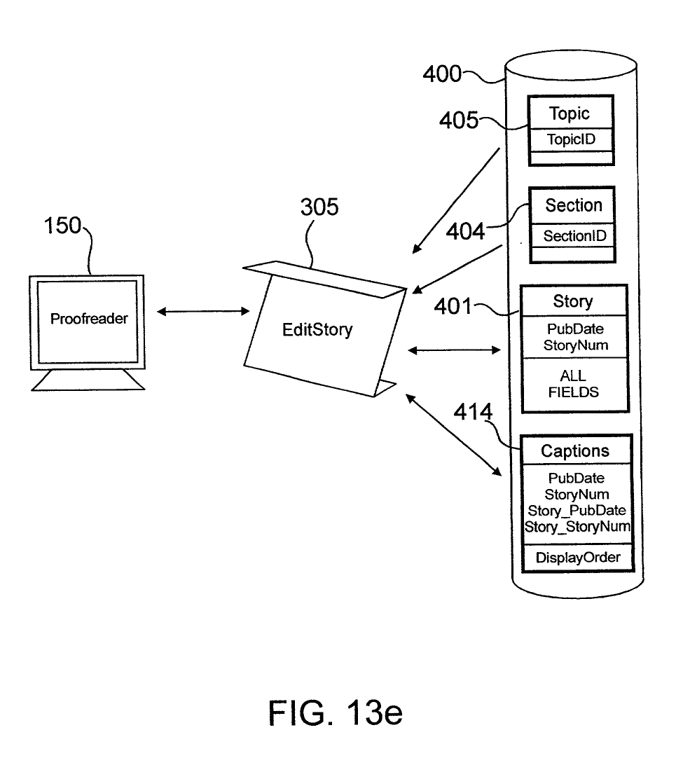

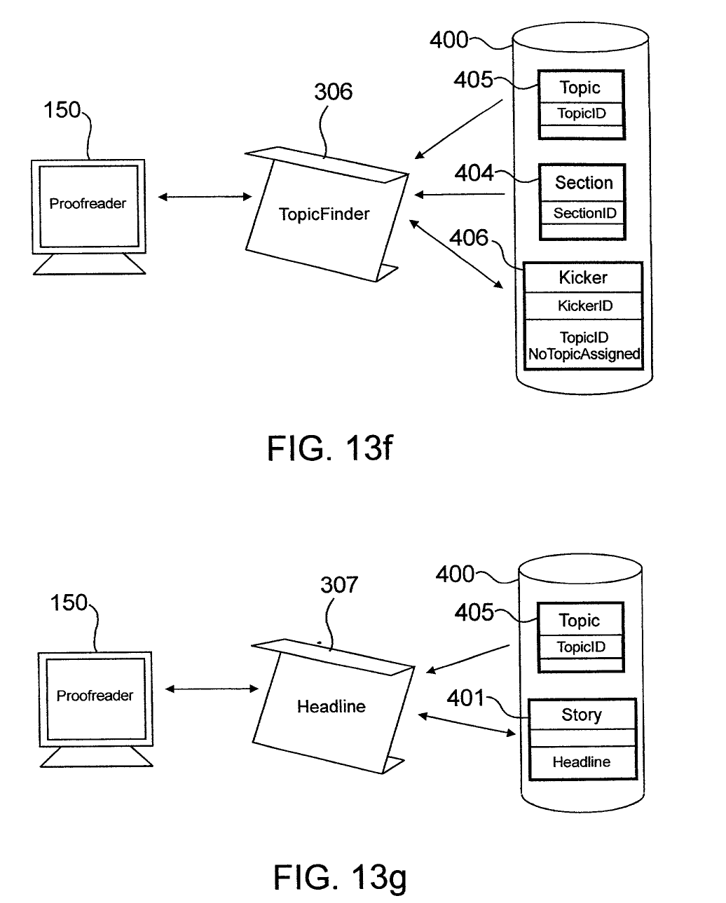

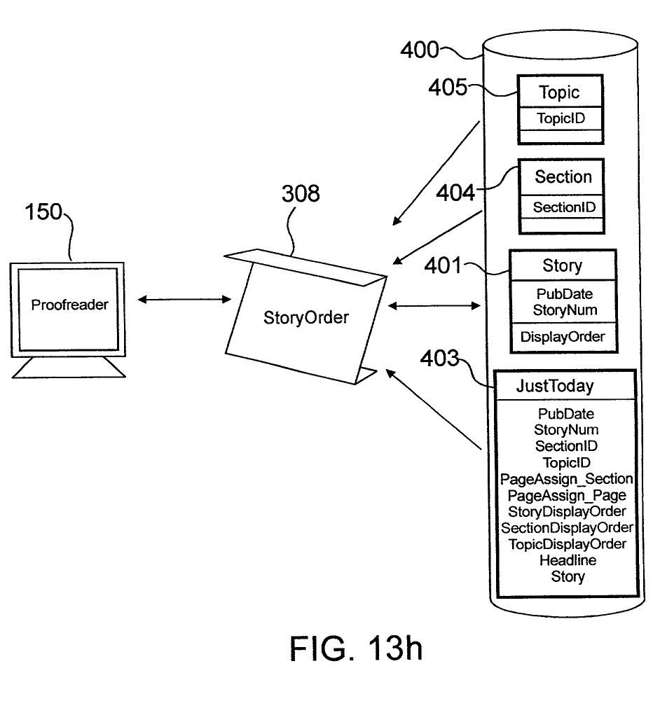

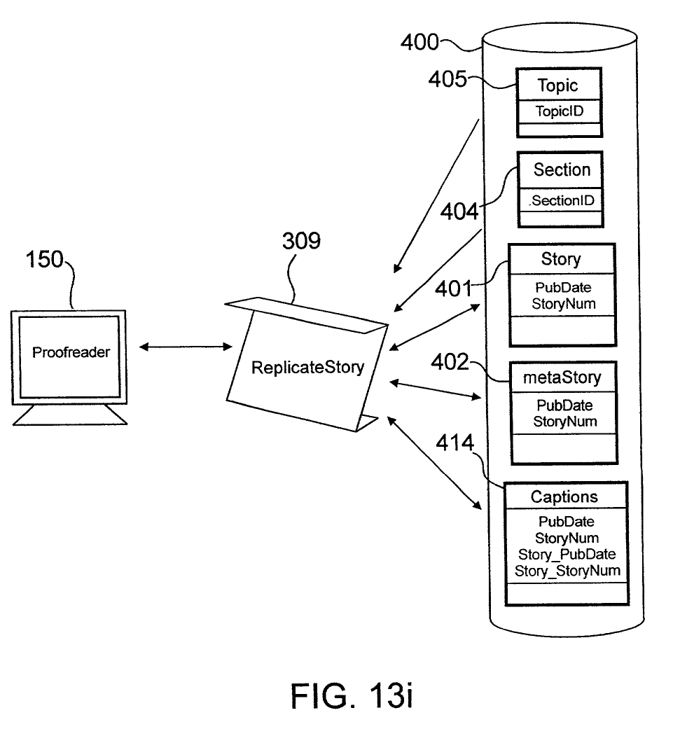

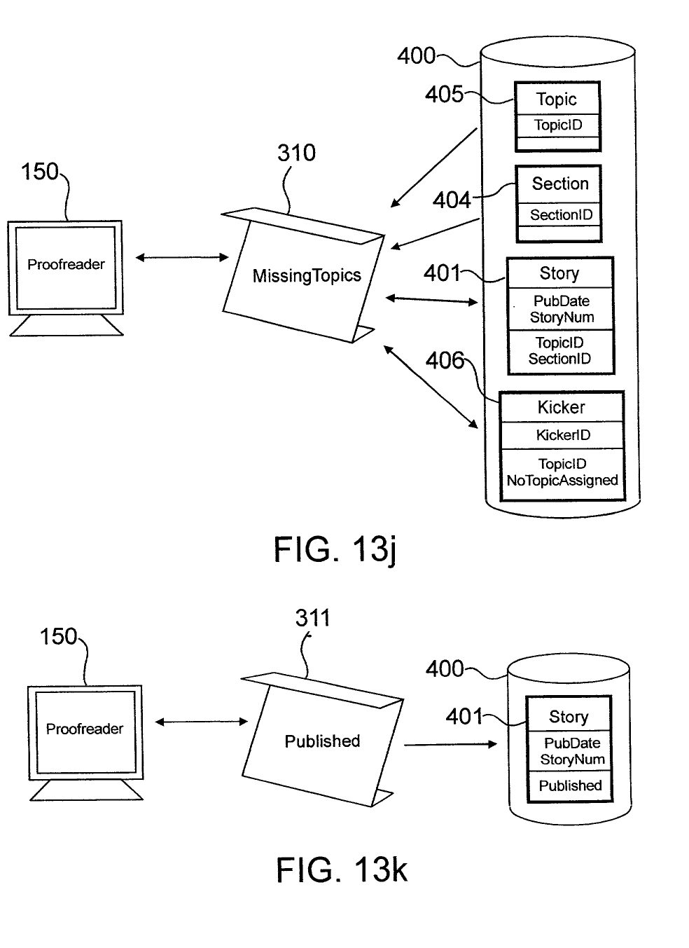

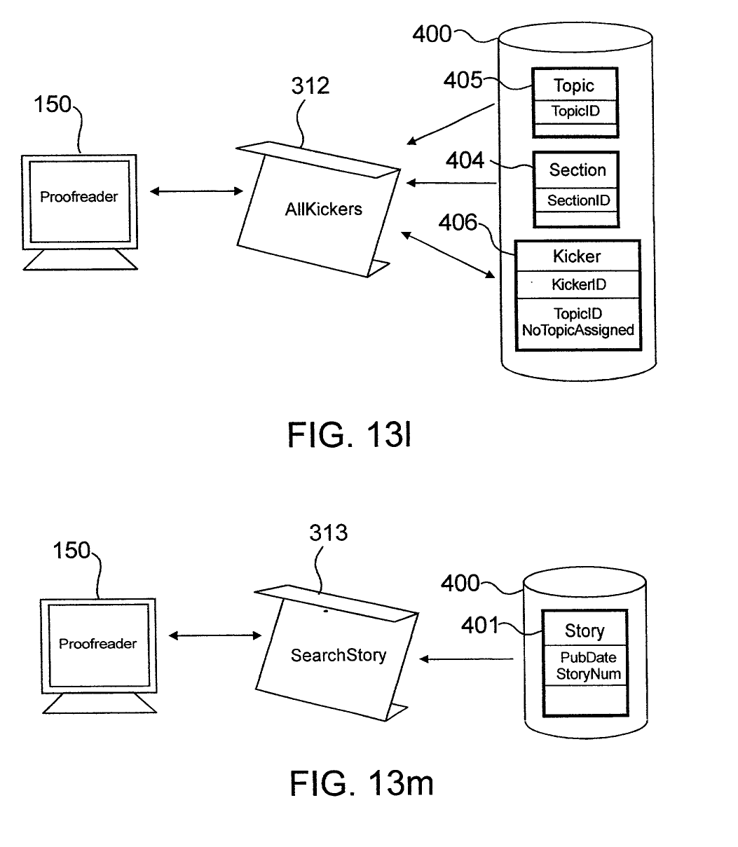

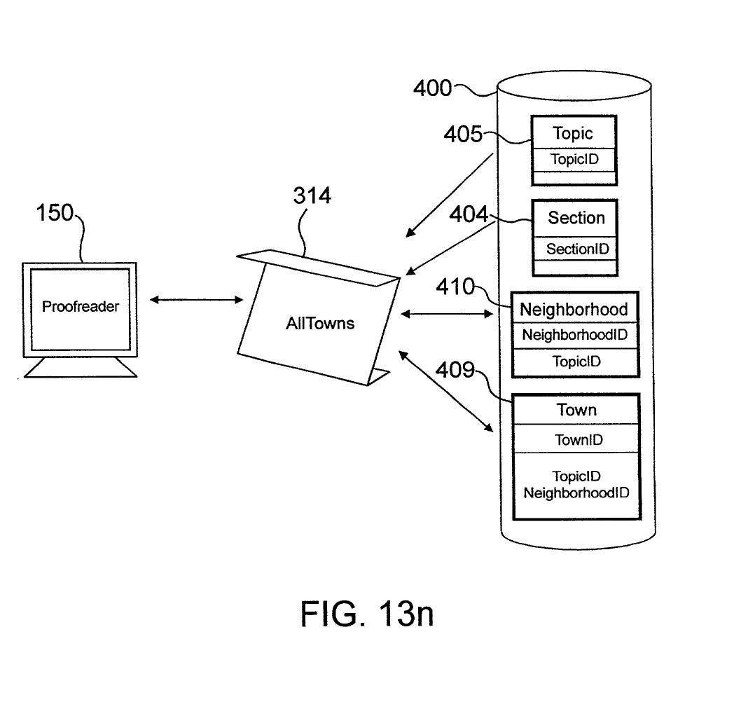

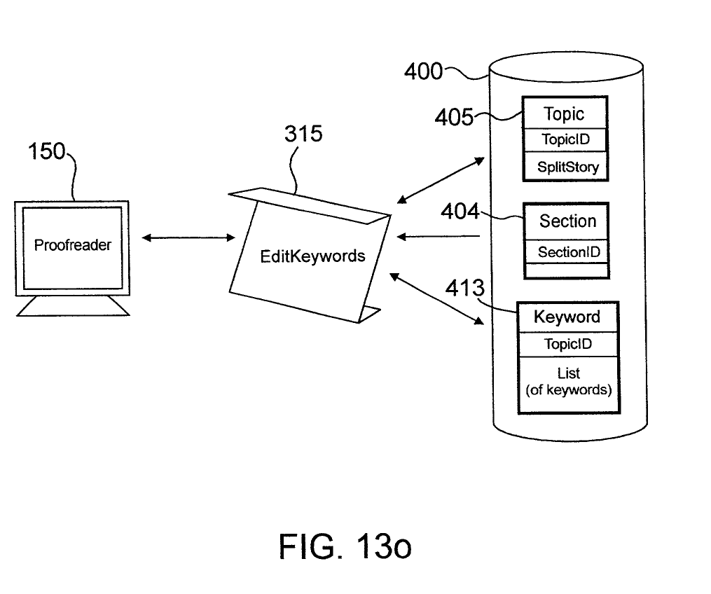

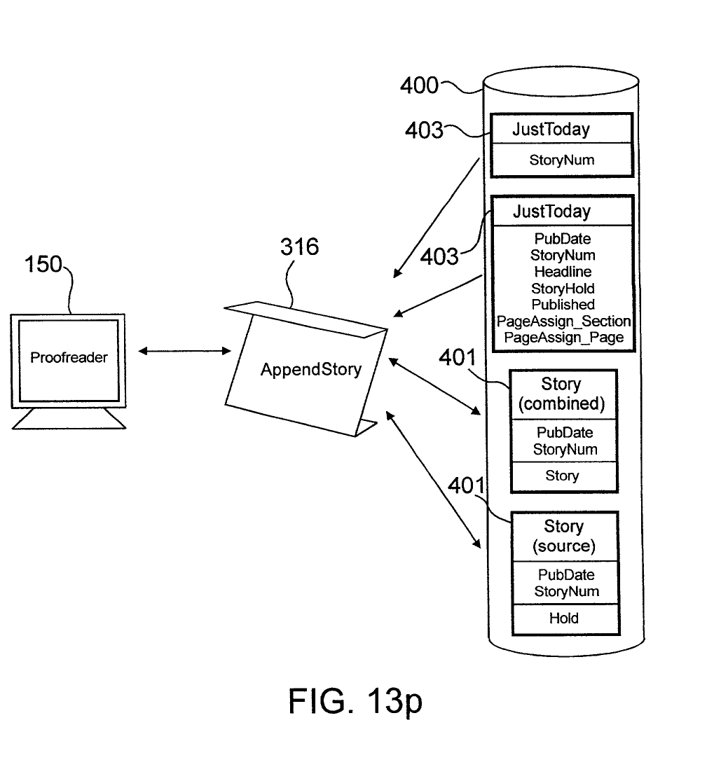

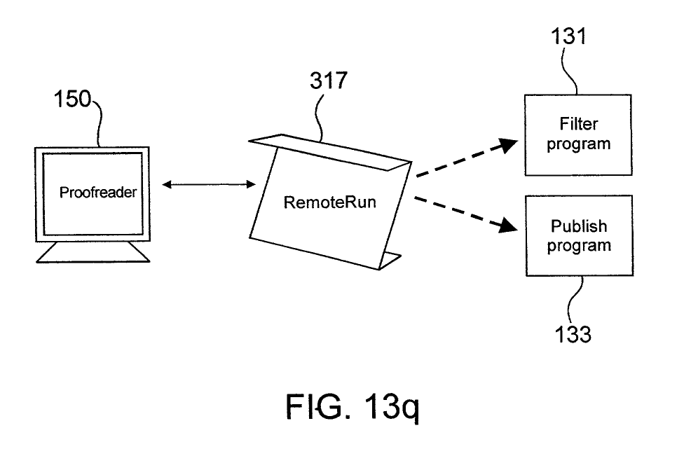

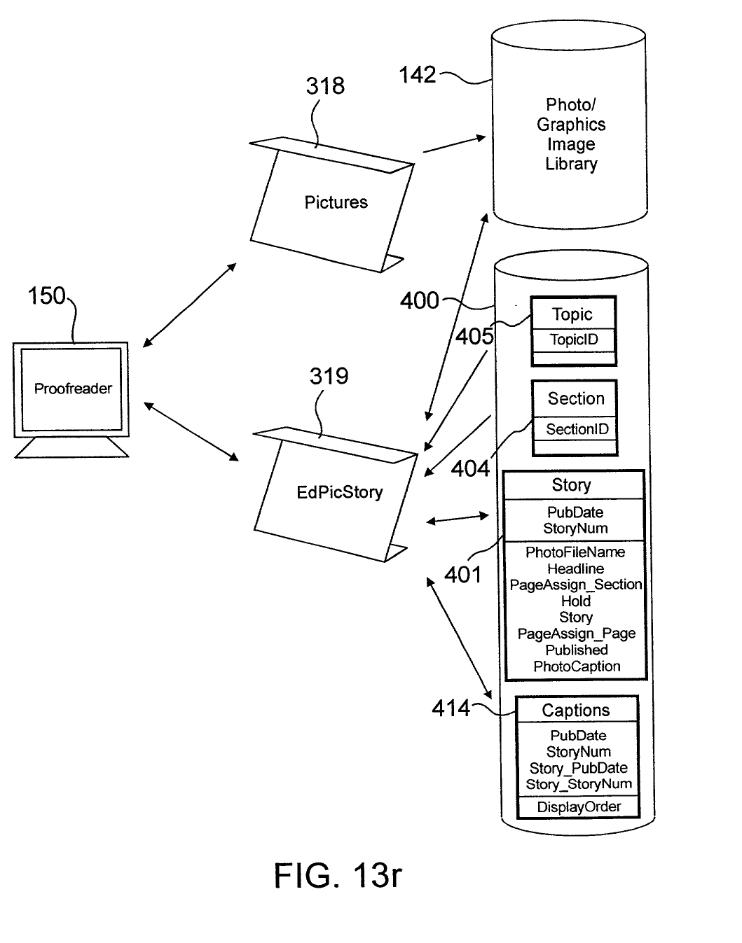

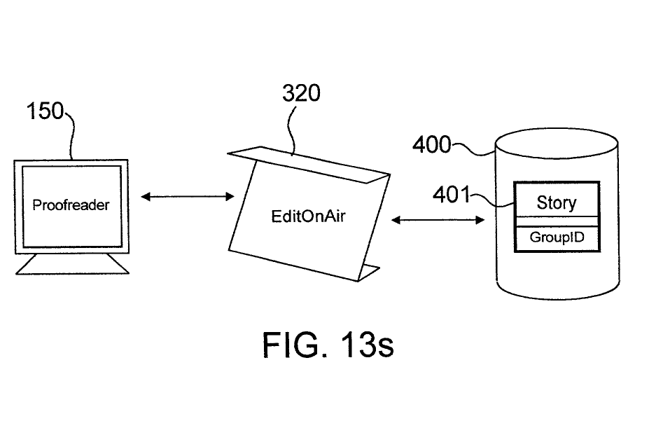

Refer now to FIG. 13. Each of the set of maintenance Web pages 300 permits a proofreader 150 to modify the contents of one or more tables in editorial database 400. The correspondence between maintenance Web pages and the table contents being updated is as follows.

See FIG. 13a. The StrayStories maintenance Web page 301 displays a list of all the stories that did not meet the filter rule criteria. This page allows proofreader 150 to place the stories on the website by updating the section ID and topic ID combination and the Published flag in Story table 401.

See FIG. 13b. The Find maintenance Web page 302 displays a list of all the headlines and links to the stories in the offline protected Website or the generally-accessible Website for a given day, enabling the proofreader 150 to edit the stories in the editorials database. This page searches story table 401.

See FIG. 13c. The EditAuthor maintenance Web page 303 allows the proofreader 150 to update the AuthornDs, Maintenance flag, and Published flag in story table 401, update the author information in author table 407, inserting a new Author record if necessary, and update the author information in multiple authors table 412, inserting a new multiple authors table record if necessary. This page is used to correct author(s) information specified for a story.

See FIG. 13d. The EditPress maintenance Web page 304 allows proofreader 150 to update the Press, Maintenance flag, and Published flag in story table 401, and update the press information in press table 408, inserting a new press table record if necessary. This page is used to correct press(s) information specified for a story.

See FIG. 13e. The EditStory maintenance Web page 305 allows proofreader 150 to update all fields in story table 401. This page is used to correct information of any type in story table 401.

See FIG. 13f The TopicFinder maintenance Web page 306 displays a list of kickers that are not assigned to a location on the website. It lets proofreader 150 assign or not assign the kickers by updating SectionID/TopicID combination in the story table 401, and by updating the TopicID and NoTopicAssigned flag in kicker table 406.

See FIG. 13g. The Headline maintenance Web page 307 allows proofreader 150 to add a headline to a story, or change a story's headline. It updates the Headline in story table 401.

See FIG. 13h. The StoryOrder rmaintenance Web page 308 allows proofreader 150 to place the stories on the section or topic Web pages in order of importance. It updates the StoryOrder and the Hold flag in story table 401. The order in which stories appear on the pages of the Website is determined initially by the section and page in which the story appeared in the printed newspaper. This ordering is modified by the proofreader 150 using StoryOrder maintenance Web page 308.

See FIG. 13i. The ReplicateStory maintenance Web page 309 allows proofreader 150 to create multiple copies of a story. ReplicateStory maintenance Web page 309 assigns a new StoryNum value for the story copy, and then creates a copy of the story's records in story table 401, meta story table 402, and captions table 414.

See FIG. 13j. The MissingTopics maintenance Web page 310 displays a list of kickers assigned to topics that no longer exist. This page lets proofreader 150 assign a kicker to the correct topic. It updates the Topic in kicker table 406 and the Topic and Section in story table 401.

See FIG. 13k. The Published maintenance Web page 311 allows proofreader 150 to change the status of stories so they can be republished on the Website. It updates the Published flag in story table 401.

See FIG. 131. The AllKickers maintenance Web page 312 works as follows. Stories can be assigned to a topic, or location, on the website programmatically by applying the filter rules to each story or by using the kicker (bold underlined text above the story Web page). Maintenance Web page 312 allows proofreader 150 to add, change or eliminate the topic ID assigned to a kicker. The sectionid/topicid combination is used to place stories in the correct area of the website. It updates the's TopicID and NoTopicAssigned flag in kicker table 406.

See FIG. 13m. The SearchStory maintenance Web page 313 allows proofreader 150 to search for stories in editorial database 400.

See FIG. 13n. The AllTowns maintenance Web page 314 works as follows: Stories can be assigned to a topic, or location, on the website programmatically by applying the filter rules to each story or by using the dateline (first word, usually a town name in capital letters with a dash just before the story starts, EX: NEW YORK-It will . . . ). This maintenance page allows proofreader 150 to update the topic ID for a town. It updates the TopicID, NeighborhoodID, and NoTopicAssigned flag in town table 409, and the NeighborhoodID and TopicID in neighborhood table 410, inserting a new neighborhood table record if necessary.

See FIG. 13o. The EditKeywords maintenance Web page 315 works as follows: Keyword combinations are also used in the assignment of stories to topics, or locations, on the Website. This maintenance Web page is used by proofreader 150 to update the Website placement (by topic) of stories containing those keywords. This page updates the TopicID and List in keyword table 413, and SplitStory in topic table 405.

See FIG. 13p. The AppendStory maintenance Web page 316 allows proofreader 150 to append a story to the end of another story. It updates the Story, Published flag and Hold flag in story table 401.

See FIG. 13q. The RemoteRun maintenance Web page 317 allows proofreader 150 to start execution of filter program 131 and/or publish program 133.

See FIG. 13r. The EdPicStory and Pictures maintenance Web pages 318 and 319 respectively allow proofreader 150 to associate one or more images in photo and graphic image library 142 with a specific story in editorial database 400. It updates the PhotoFileName for captions and PhotoCaption for stories in story table 401, and Story_PubDate and Story_StoryNum in captions table 414. The captions table allows for accessing the story table 401 to find the stories associated with the captions.

See FIG. 13s. The EditOnAir maintenance Web pages 320 allows proofreader to switch the assignment of On-Air and Sports Today stories between each other.

The Editorial Archive Process

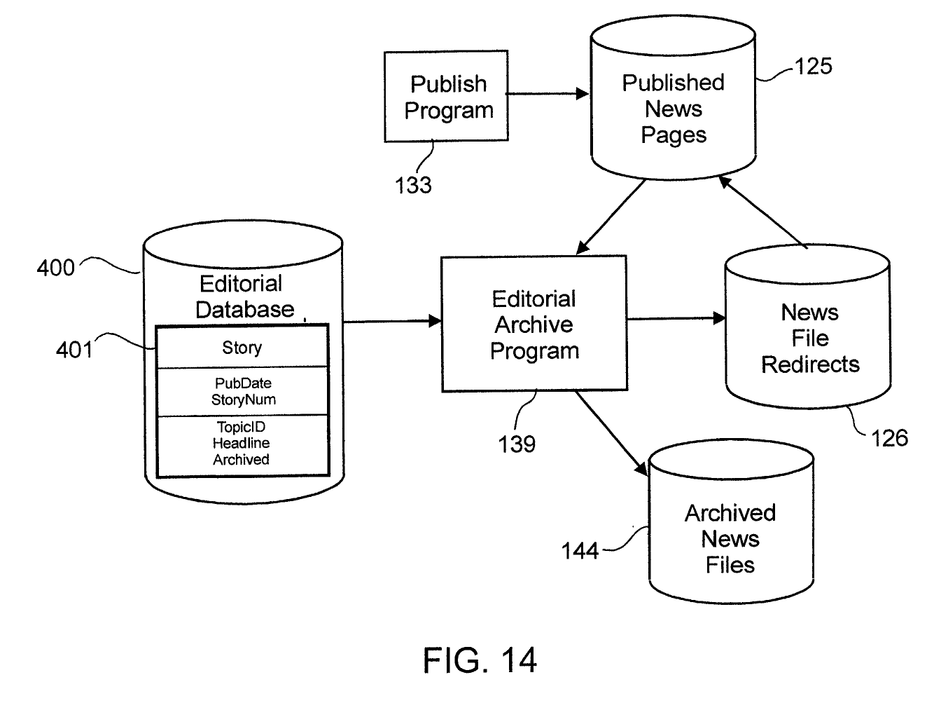

Refer now to FIG. 14. Editorial archival program 139 reads story table 401 in the editorial database 400, retrieves all stories for which the story's latest display date has passed, moves the Web'pages for all such stories to an archive of news files 144, marks as archived all such stories in story table 401 in editorial database 400, and replaces the archived stories with redirect Web pages 126 displaying redirection instructions to an outside News Library source.

The Classified Maintenance Process

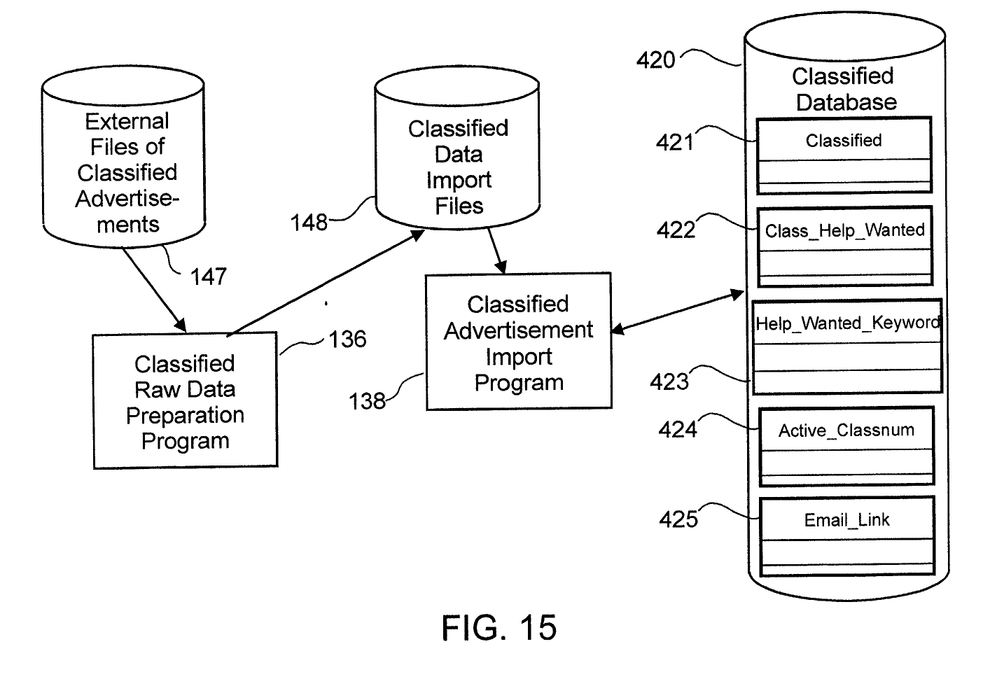

Refer to FIG. 15. Classified raw data preparation program 136 reads external files 147 of classified advertisements, converts the advertisements into a common format, and writes the advertisements into classified data import files 148. Classified advertisement import program 138 reads classified data import files 148, and updates classified table 421, class_help_wanted table 422, help wanted_keyword table 423, active_classnum table 424, and email_link table 425 in classified database 420. In the course of updating classified table 421, classified advertisement import program 138 scans the text of each classified advertisement to find URLs (links) and electronic mail addresses, and converts each such link or address found into a common format for display on a Web page. This display allows a prospective buyer to obtain more information about an advertised item simply by displaying the linked Web page.

The Death Notices Maintenance Process

Refer to FIG. 16. Death raw data preparation program 132 reads externals files 127 of death notifications, converts the notifications into a common format, and writes the notifications into death notice import files 128. Death notice import program 134 reads death notice import files 128 and obituary stories from the story table 401 in editorial database 400, and updates death table 441 in deaths database 440. New death information is added to death table 441, while death information updating existing entries in death table 441 is applied to the existing entries.

The Electronic Mail Maintenance Process

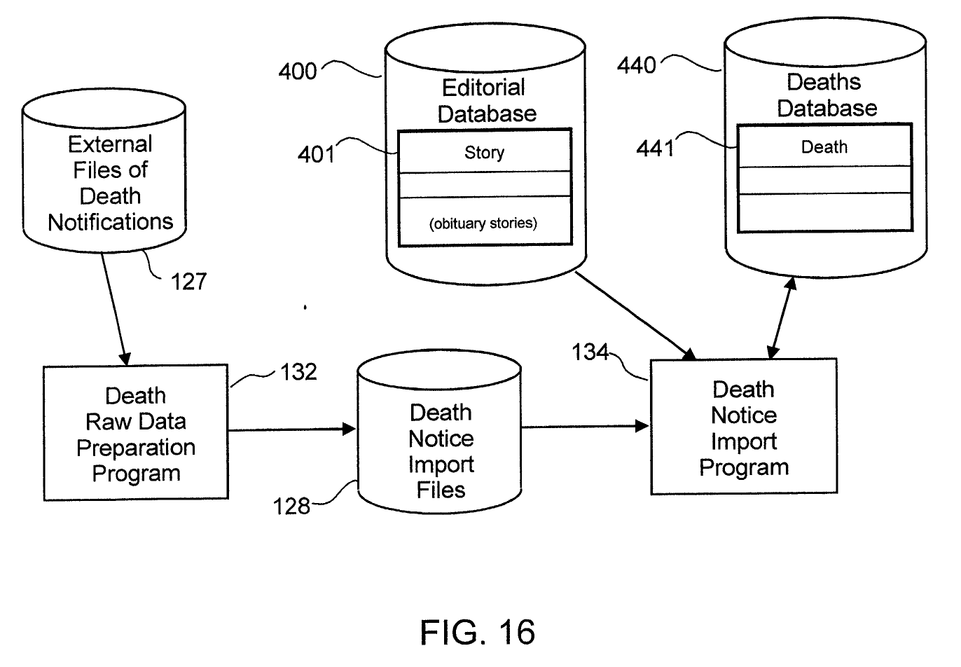

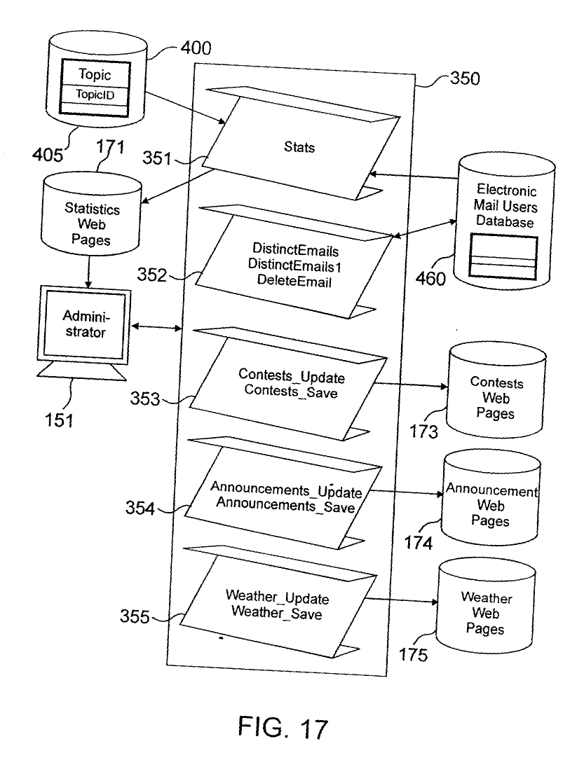

Refer to FIG. 17. Administrator 151 manages an electronic mail users database 460 via Web pages 352, which provide for surveying the list of subscribers and deleting subscriber records. Administrator 151 also maintains three sets of Web pages to be mailed to subscribers: a contests Web page 173, maintained via Web page 353, an announcements Web page 174, maintained via Web page 354, and a weather Web page 175, maintained via Web page 355. Administrator 151 also uses a set of statistics Web pages 171 to review statistics concerning electronic mail users and their selections of news topics. Statistics program 351 combines the set of topics from topic table 405 in editorial database 400 with subscriber preferences stored in electronic mail users database 460 to create its statistics for administrator use.

The electronic mail subscriber controls his or her own subscription through Web access to a separate Website, which maintains the electronic mail address and the news selections specified by each user in the electronic mail users database 460.

The Electronic Mail News Delivery Process

Refer to FIG. 18. News electronic mail program 358 reads contest Web pages 173, announcement Web pages 174, weather Web pages 175, and all current day headline information 180 created for electronic mail use by publish program 133. News electronic mail program 358 then reads the list of electronic mail subscribers stored in electronic mail users database 460, generates news electronic mail messages 178 for each user, and mails the messages out to the users 3 via the World Wide Web 40.

### CONCLUSION, RAMIFICATIONS, AND SCOPE OF INVENTION

From the above descriptions, figures and narratives, the invention's advantages in presenting news on the World Wide Web should be clear. The economy and accuracy of the invention's automated system reduces significantly the burden required to convert print-media news documents into a well-organized and richly-interconnected set of news Web pages.

Although the description, operation and illustrative material above contain many specificities, these specificities should not be construed as limiting the scope of the invention but as merely providing illustrations and examples of some of the preferred embodiments of this invention.

Thus the scope of the invention should be determined by the appended claims and their legal equivalents, rather than by the examples given above.

1. An apparatus for translating and recomposing electronic news text and images from a form derived from print publication electronic files to a form displayable on the World Wide Web, comprising:
a server computer system, comprising one or more interconnected computer processors each with its own memory and secondary storage, for storing, converting, organizing and displaying news information on the World Wide Web, including means for receiving a plurality of print publication electronic files comprising news story text data and news story image data;
an editorial database for storing information extracted from the print publication electronic files,
a news story filter program for extracting text information from the print publication electronic files, converting the text information into a database format, and storing the text information in the editorial database, and
a news story publishing program for extracting text information from the editorial database, converting the text information into a form suitable for display on the World Wide Web, and storing the text information in a set of newspaper story text files capable of display at a news Website on the World Wide Web.

2. The apparatus of claim 1 further comprising:
a plurality of templates for organizing the display of the news text files and edited news files on the World Wide Web,
a set of news Web pages capable of display on the World Wide Web.

3. An apparatus for translating and recomposing electronic news text and images from a form derived from print publication electronic data files to a form displayable on the World Wide Web, comprising:
a server computer system, comprising one or more interconnected computer processors each with its own memory and secondary storage, for storing, converting, organizing and displaying news information on the World Wide Web,
an editorial database for storing information extracted from the print publication electronic data files,
a news story filter program for extracting text information from the print publication electronic data files, converting the text information into a database format, and storing the text information in the editorial database, and
a news story publishing program for extracting text information from the editorial database, converting the text information into a form suitable for display on the World Wide Web, and storing the text information in a set of news text files capable of display at a news Website on the World Wide Web.

4. The apparatus of claim 1 wherein the plurality of print publication electronic files comprises one or more data files selected from the group consisting of:
a set of newspaper story text electronic data files each containing one or more news stories,
a set of newspaper image electronic data files each containing one or more news pictures,
a set of classified advertisement electronic data files each containing one or more classified advertisements,
a set of death notice electronic data files each containing one or more notices of deaths,
a news image library for containing the newspaper image electronic data files in a common format, and
a set of news summary electronic data files to be mailed electronically to electronic news subscribers.

5. The apparatus of claim 1 further comprising an electronic news subscriber database for storing electronic mail addresses and information preferences of electronic news subscribers.

6. The apparatus of claim 1 further comprising a news image conversion program for extracting image information from the newspaper image data files, converting the image information into files in a common image format, and storing the image information in image files in an electronic news image library.

7. The apparatus of claim 1 further comprising:
a classified advertisement database for containing classified advertisement information,
a classified notices program for editing text classified advertisement information and storing the edited classified advertisement information in the classified advertisement database, and
a classified notices maintenance program for updating edited classified advertisement information stored in the classified advertisement database.

8. The apparatus of claim 1 further comprising:
a death notices database for containing death notice information, and a death notices program for editing text death notice information and storing the edited death notice information in the death notices database.

9. The apparatus of claim 1 further comprising:
a classified advertisement and death notices database for containing classified advertisement information,
a classified notices program for editing text classified advertisement information and storing the edited classified advertisement information in the classified advertisement and death notices database,
a classified notices maintenance program for updating edited classified advertisement information stored in the classified advertisement and death notices database,
a death notices program for editing text death notice information and storing the edited death notice information in the classified advertisement and death notices database.

10. The apparatus of claim 1 further comprising:
an editorial maintenance program for proofreading and editing the contents of the editorial database, associating some news stories in the editorial database with image files in the electronic news image library, and initiating the news story filter program and the news story publishing program.

11. The apparatus of claim 1 further comprising:
an electronic news archive for containing past news text information, and
a news story archive program for extracting text information from the newspaper story text data files, converting the text information into an archive format, and storing the text information in the electronic news archive.

12. The apparatus of claim 2 wherein each template contains a plurality of lists of links to other news stories and news Web pages.

13. The apparatus of claim 12 wherein a list of links contains a link to each section of the news.

14. The apparatus of claim 12 wherein a list of links contains a link to each topic of the news in a single section of the news.

15. The apparatus of claim 2 wherein the templates comprise one or more templates selected from the group consisting of.
a main Web page template for presenting a plurality of top news stories,
a section Web page template for presenting a plurality of top news stories of one section of the news,
a topic Web page template for presenting a plurality of top news stories in one topic of the news, and
a story Web page template for presenting a single news story.

16. The apparatus of claim 2 wherein the templates comprise one or more templates selected from the group consisting of:
a baseball box score Web page template for presenting a plurality of baseball box scores,
a baseball leaders Web page template for presenting a plurality oftop news stories of one section of the news,
a baseball standings Web page template for presenting the relative team standings of a plurality of baseball leagues,
a football box score Web page template for presenting a plurality of football box scores, and
a football standings Web page template for presenting the relative team standings of a plurality of football leagues.

17. The apparatus of claim 2 wherein the templates comprise one or more templates selected from the group consisting of:
a bridal Web page template for presenting a plurality of wedding announcements and related information,
an entertainment Web page template for presenting a plurality of entertainment event announcements and entertainment sources,
a movie reviews Web page template for presenting a plurality of reviews of movies,
a cartoon Web page template for presenting a plurality of cartoons, and
a travel Web page template for presenting a plurality of travel related stories and related information.

18. The apparatus of claim 2 wherein the templates comprise one or more templates selected from the group consisting of:
an archival Web page template for presenting an entry allowing a reader to search the news story archive.

19. The apparatus of claim 1 wherein the editorial database comprises a relational editorial database supported by a relational database management system.

20. The relational editorial database of claim 19 wherein said relational database comprises:
one or more tables of news story texts and news story classifications,
one or more tables of news topic information and news topic classifications,
one or more tables of news section information and news section classifications,
one or more tables of geographic classification information,
one or more tables of news story source information,
one or more tables of news story linkage information, and
one or more tables of news image caption information.

21. The editorial maintenance program of claim 10 further comprising a set of maintenance subprograms for updating information stored in a plurality of tables in the editorial database.

22. The electronic news archive of claim 11 wherein the electronic news archive comprises a relational database.

23. The electronic news archive of claim 11 wherein the electronic news archive comprises a set of electronic files related to each other by their names, their content, or a separate directory means of association.

24. The apparatus of claim 4 wherein the news image library comprises a set of electronic files related to each other by their names, their content, or a separate directory means of association.

25. The set of newspaper story text data files of claim 1 wherein each text data file comprises:
a news story,
formatting information defining the appearance of said news story for readers, and
descriptive information defining the content of said news story.

26. The story text data file of claim 25 wherein the formatting information is stored in the form of codes of one or more text markup languages.

27. The story text data file of claim 26 wherein the markup language used is HTML.

28. The story text data file of claim 25 wherein the descriptive information is stored in the form of codes of one or more text markup languages.

29. The story text data file of claim 28 wherein the markup language used is HTML.

30. The story text data file of claim 25 wherein the descriptive information is stored in the form of keywords in the text of the news story.

31. The apparatus of claim 2 wherein a plurality of the set of news Web pages comprise text files.

32. The text files of claim 31 wherein a plurality of the text files contain information which may be updated at the time the file is accessed for display.

33. The apparatus of claim 2 wherein a plurality of the set of news Web pages comprise image files.

34. The apparatus of claim 1 wherein the server computer system comprises:
a conversion computer subsystem with its own main memory and secondary storage, for reorganizing the newspaper text data files into news Web pages, and
a Web server computer system with its own main memory and secondary storage, for retrieving, updating and displaying the news Web pages for a reader.

35. The classified advertisement database of claim 7 wherein the classified advertisement database comprises a relational classified advertisement database supported by a relational database management system.

36. The relational classified advertisement database of claim 35 wherein said relational database comprises:
one or more tables of classified advertisement information,
one or more tables of help wanted information, and
one or more tables of help wanted keyword information.

37. The death notices database of claim 8 wherein the death notices database comprises a relational death notices database supported by a relational database management system.

38. The relational death notices database of claim 37 wherein said relational database comprises one or more tables of death notice information.

39. The apparatus of claim 9 wherein the classified advertisement database and the death notices database together comprise a relational classified and death notices database supported by a relational database management system.

40. The relational classified and death notices database of claim 39 wherein said relational database comprises:
one or more tables of classified advertisement information,
one or more tables of help wanted information,
one or more tables of help wanted keyword information, and
one or more tables of death notice information.

41. The electronic news subscriber database of claim 5 wherein the electronic news subscriber database comprises a relational database.

42. The electronic news subscriber database of claim 41 wherein said relational database comprises:
one or more tables of subscriber information.

43. The electronic news subscriber database of claim 5 wherein the electronic news subscriber database comprises a set of electronic files related to each other by their names, their content, or a separate directory means of association.

44. The set oftemplates of claim 2 wherein each template includes embedded program code executable only by the server computer system.

45. The set of templates of claim 2 wherein each template includes embedded directives for substitution of template content with the contents of other electronic files.

46. The filter program of claim 1 further comprising:
a first filter subprogram to determine a story's topic classification based on combinations of multiple data elements in a story,
a second filter subprogram to determine a story's topic classification by using the story's kicker to determine a topic associated with the kicker in the editorial database,
a third filter subprogram to determine a story's topic classification by using the story's town to determine a topic associated with the town in the editorial database, and
a fourth filter subprogram to determine a story's topic classification by using a weighted count of keywords found to select the topic associated in the editorial database with the most heavily weighted keyword.

47. The filter program of claim 1 further comprising a subprogram to initiate execution of the publish program.

48. The publishing program of claim 1 further comprising:
a story Web page creation subprogram to embed news story text and images in a story Web page template,
a main Web page creation subprogram to embed multiple news story texts and images in a main Web page template,
a section Web page template subprogram to embed multiple news story texts and images in a section Web page template, and
a topic Web page template subprogram to embed multiple news story texts in a topic Web page template.

49. The editorial maintenance program of claim 10 further comprising:
a stray stories maintenance Web page for enabling a proofreader to place a story on the website by updating the story's section ID and topic ID combination in the editorial database,
a story finding maintenance Web page for displaying for a proofreader a list of all the headlines for a given day, thereby enabling the proofreader to create a link to a specific story in the editorial database,
a story editing maintenance Web page for enabling a proofreader to update all information for a story in the editorial database,
a headline maintenance Web page for enabling a proofreader to add a headline to a story, or change a story's headline, in the editorial database,
a story ordering maintenance Web page for enabling a proofreader to place the stories on the section Web pages in order of importance,
a published status maintenance Web page for enabling a proofreader to change the published status of stories in the editorial database to permit their republication on the news Website,
a story search Web page for enabling a proofreader to search for stories in the editorial database,
a program starting maintenance Web page for enabling a proofreader to start execution of the news story filter program and the news story publish programs, and
a picture linkage maintenance Web page for enabling a proofreader to associate one or more images in the photo and graphic image library with a specific story in the editorial database.

50. The editorial maintenance program of claim 10 further comprising:
an author editing maintenance Web page for enabling a proofreader to correct author information specified in the editorial database for a story,
a press editing maintenance Web page for enabling a proofreader to correct press information specified in the editorial database for a story,
a town topic maintenance Web page for enabling aproofreader to update the topic ID for a town in the editorial database,
a keyword maintenance Web page for enabling a proofreader to update a story's assigned topic in the editorial database,
a kicker assignment maintenance Web page for enabling a proofreader to assign a kicker to the correct topic in the editorial database,
a topic finding maintenance Web page for enabling a proofreader to assign or reassign kickers in the editorial database,
a kicker topic maintenance Web page for enabling a proofreader to add, change or eliminate the topic ID assigned to a kicker in the editorial database,
a story appending maintenance Web page for enabling a proofreader to append a story to the end of another story in the editorial database, and
a story replication maintenance Web page for enabling a proofreader to create multiple copies of a story in the editorial database.

51. A method for translating and recomposing news text and images from a form capable of print publication to a form displayable on the World Wide Web, comprising the steps of:
extracting raw story text and classification information from newspaper story electronic data files,
converting the raw story text and classification information into an editorial database format,
storing the converted story text information in an editorial database in an organization determined by story classification information extracted from the raw story information,
extracting image information from newspaper image electronic data files,
converting the image information into a common image format,
storing the image information in image electronic data files in a news image library,
extracting story information from the editorial database and image electronic data files from the electronic news image library,
organizing and storing the extracted story information and image electronic data files on a news Website in a set of news Web pages suitable for display and reading on the World Wide Web, and
displaying the news Web pages to a Web user.

52. The method of claim 51 farther comprising the step of extracting text formatting information from newspaper story text electronic data files.

53. The method of claim 51 wherein the step of extracting raw story classification information from newspaper story text electronic data files comprises the steps of:
determining a story's topic classification based on combinations of multiple data elements in a story,
determining a story's topic classification by using the story's kicker to determine a topic associated with the kicker in the editorial database,
determining a story's topic classification by using the story's town to determine a topic associated with the town in the editorial database, and
determining a story's topic classification by using a weighted count of keywords found to select the topic associated in the editorial database with the most heavily weighted keyword.

54. The method of claim 51 further comprising the step of proofreading news electronic files to change their appearance and organization.

55. The method of claim 54 further comprising:
adding, changing or deleting records in the editorial database,
reorganizing records in the editorial database, and
associating news text electronic data files with available image electronic data files in the electronic news image library.

56. The method of claim 54 wherein proofreading further comprises: extracting, converting and storing story text information,
providing means for a proofreader to initiate a process for database retrieval, conversion and formatting of news text and image information for display on the World Wide Web, and
providing means for a proofreader to direct news text and image information formatted for display on the World Wide Web either to a test news Website or a public news Website.

57. The method of claim 51 wherein the step of organizing and storing the extracted story information and image electronic data files in a form suitable for display and reading on the World Wide Web, further comprises:
retrieving Web page template files defining the form and interconnections of news Web pages,
retrieving news story information from the editorial database,
executing Web page template commands to replace template directives with specific news text electronic file contents retrieved from the editorial database,
retrieving image electronic data files from the electronic news image library, and
storing the combined edited news text files and image files in a set of edited news electronic Web pages for display on the World Wide Web.

58. The method of claim 51 wherein the step of organizing and storing the extracted story information and image electronic data files in a set of news Web pages suitable for display and reading on the World Wide Web further comprises:
retrieving stored edited news electronic Web pages for display to a Web user,
executing program code in the edited news electronic Web pages to store current server information in the retrieved Web pages for the Web user, and
transmitting the edited news electronic Web pages with current information to the Web user.

59. The method of claim 51 further comprising the step of archiving text information from newspaper text electronic data files.

60. The method of claim 59 wherein the step of archiving text information from newspaper text electronic data files, further comprises:
extracting text information from newspaper text electronic data data files,
converting the text information into an archive format,
storing the text information in an electronic news archive, and
removing archived text information from the editorial database.

61. The method of claim 51, further comprising the step of selecting and sending news information to news subscribers via electronic mail.

62. The method of claim 61 wherein the step of selecting and sending news information to news subscribers via electronic mail, further comprises:
providing a means for a plurality of subscribers to request electronic mail presentation of news information,
providing a means for a subscriber to specify a plurality of selection criteria for news topics for electronic mail presentation,
extracting news information according to subscriber selection criteria,
preparing an electronic mail message for each subscriber requesting electronic mail presentation of news information, and
transmitting the electronic mail messages to all subscribers requesting electronic mail presentation of news information.

63. The method of claim 51, further comprising the step of delivering the set of news Web pages on a daily basis to the World Wide Web for presentation to Web users.

64. The method of claim 51, further comprising the step of delivering the set of news Web pages to the World Wide Web for presentation to Web users on the basis of changes in news information.
